(19) United States
(12) Patent Application Publication
(10) Pub. No.: US 2024/0163686 A1
(43) Pub. Date: May 16, 2024

(54) BEAMFORMING ENHANCEMENTS USING MACHINE LEARNING MODELS

(71) Applicant: QUALCOMM Incorporated, San Diego, CA (US)

(72) Inventors: Gaurang Naik, San Diego, CA (US); Abhishek Pramod Patil, San Diego, CA (US); George Cherian, San Diego, CA (US); Yanjun Sun, San Diego, CA (US); Sai Yiu Duncan Ho, San Diego, CA (US); Alfred Asterjadhi, San Diego, CA (US); Abdel Karim Ajami, Lakeside, CA (US); Lin Yang, San Diego, CA (US)

(21) Appl. No.: 18/162,394

(22) Filed: Jan. 31, 2023

Related U.S. Application Data
(60) Provisional application No. 63/383,664, filed on Nov. 14, 2022.

(51) Int. Cl. H04W 16/28; H04B 7/06; H04W 8/22; H04W 24/08

(52) U.S. Cl. CPC H04W 16/28; H04B 7/0617; H04W 8/22; H04W 24/08

(57) ABSTRACT

Methods, systems, and devices for wireless communications are described. A first wireless communication device may determine a first set of parameters for communicating with a second wireless communication device within a first set of time intervals, the first set of parameters associated with a beamforming procedure. The first wireless communication device may predict, based on inputting the first set of parameters to a machine learning model, a second set of parameters corresponding to a second set of time intervals in the future after the first set of time intervals. The first wireless communication device may select a beamforming configuration for communications between the first wireless communication device and the second wireless communication device based on the second set of parameters, and may communicate with the second wireless communication device within the second set of time intervals in accordance with the beamforming configuration.

### CROSS REFERENCE

The present Application for Patent claims the benefit of U.S. Provisional Patent Application No. 63/383,664 by Naik et al., entitled “BEAMFORMING ENHANCEMENTS USING MACHINE LEARNING MODELS,” filed Nov. 14, 2022, assigned to the assignee hereof, and expressly incorporated by reference in its entirety herein.

### TECHNICAL FIELD

The following relates to wireless communications, including techniques for predicting beams or beamforming parameters using machine learning models.

### DESCRIPTION OF THE RELATED TECHNOLOGY

A wireless local area network (WLAN) may be formed by one or more access points (APs) that provide a shared wireless communication medium for use by a number of client devices also referred to as stations (STAs). The basic building block of a WLAN conforming to the Institute of Electrical and Electronics Engineers (IEEE) 802.11 family of standards is a Basic Service Set (BSS), which is managed by an AP. Each BSS is identified by a Basic Service Set Identifier (BSSID) that is advertised by the AP. An AP periodically broadcasts beacon frames to enable any STAs within wireless range of the AP to establish or maintain a communication link with the WLAN.

Many wireless fidelity (Wi-Fi) deployments may use some or all of the 2.4 gigahertz (GHz), 5 GHz, and/or 6 GHz bands, which may be referred to as “sub-7” GHz bands. Future Wi-Fi enhancements aim to leverage multi-link operation techniques to facilitate the determination of communication parameters within other frequency bands, such as a 60 GHz frequency band. While the 60 GHz band may offer a large swath of resources for Wi-Fi devices to use, the 60 GHz band is not widely used due to several challenges, including high propagation loss. Beam training procedures may be used to determine narrow beams that reduce propagation loss. However, in many Wi-Fi deployments, wireless communication devices may wait until a wireless link degrades or is completely lost before performing a new beam training procedure, which may increase latency associated with wireless communications.

### SUMMARY

The systems, methods and devices of this disclosure each have several innovative aspects, no single one of which is solely responsible for the desirable attributes disclosed herein.

One innovative aspect of the subject matter described in this disclosure can be implemented in a method for wireless communication at a first wireless communication device. The method may include determining a first set of parameters including parameters used within each time interval of a first set of time intervals for previous communications with a second wireless communication device, the first set of parameters associated with a beamforming procedure between the first wireless communication device and the second wireless communication device, predicting, after the first set of time intervals and in accordance with inputting the first set of parameters to a machine learning model, a second set of parameters corresponding to a second set of time intervals in the future, selecting a beamforming configuration for communications between the first wireless communication device and the second wireless communication device in accordance with the second set of parameters, and communicating with the second wireless communication device within the second set of time intervals in accordance with the beamforming configuration.

Another innovative aspect of the subject matter described in this disclosure can be implemented in an apparatus for wireless communication at a first wireless communication device. The apparatus may include a processor, memory coupled with the processor, and instructions stored in the memory. The instructions may be executable by the processor to cause the apparatus to determine a first set of parameters including parameters used within each time interval of a first set of time intervals for previous communications with a second wireless communication device, the first set of parameters associated with a beamforming procedure between the first wireless communication device and the second wireless communication device, predict, after the first set of time intervals and in accordance with inputting the first set of parameters to a machine learning model, a second set of parameters corresponding to a second set of time intervals in the future, select a beamforming configuration for communications between the first wireless communication device and the second wireless communication device in accordance with the second set of parameters, and communicate with the second wireless communication device within the second set of time intervals in accordance with the beamforming configuration.

Another innovative aspect of the subject matter described in this disclosure can be implemented in an apparatus for wireless communication at a first wireless communication device. The apparatus may include means for determining a first set of parameters including parameters used within each time interval of a first set of time intervals for previous communications with a second wireless communication device, the first set of parameters associated with a beamforming procedure between the first wireless communication device and the second wireless communication device, means for predicting, after the first set of time intervals and in accordance with inputting the first set of parameters to a machine learning model, a second set of parameters corresponding to a second set of time intervals in the future, means for selecting a beamforming configuration for communications between the first wireless communication device and the second wireless communication device in accordance with the second set of parameters, and means for communicating with the second wireless communication device within the second set of time intervals in accordance with the beamforming configuration.

Another innovative aspect of the subject matter described in this disclosure can be implemented in a non-transitory computer-readable medium storing code for wireless communication at a first wireless communication device. The code may include instructions executable by a processor to determine a first set of parameters including parameters used within each time interval of a first set of time intervals for previous communications with a second wireless communication device, the first set of parameters associated with a beamforming procedure between the first wireless communication device and the second wireless communication device, predict, after the first set of time intervals and in accordance with inputting the first set of parameters to a machine learning model, a second set of parameters corresponding to a second set of time intervals in the future, select a beamforming configuration for communications between the first wireless communication device and the second wireless communication device in accordance with the second set of parameters, and communicate with the second wireless communication device within the second set of time intervals in accordance with the beamforming configuration.

### BRIEF DESCRIPTION OF THE DRAWINGS

Details of one or more implementations of the subject matter described in this disclosure are set forth in the accompanying drawings and the description below. However, the accompanying drawings illustrate only some typical aspects of this disclosure and are therefore not to be considered limiting of its scope. Other features, aspects, and advantages will become apparent from the description, the drawings and the claims.

FIG. 1 illustrates an example of a wireless communications system that supports techniques for predicting beams and/or beamforming parameters using machine learning models.

FIG. 2 illustrates an example of a wireless communications system that supports techniques for predicting beams and/or beamforming parameters using machine learning models.

FIG. 3 illustrates an example of a wireless communications system that supports techniques for predicting beams and/or beamforming parameters using machine learning models.

FIG. 4 illustrates an example of a machine learning configuration that supports techniques for predicting beams and/or beamforming parameters using machine learning models.

FIG. 5 illustrates an example of a communications configuration that supports techniques for predicting beams and/or beamforming parameters using machine learning models.

FIG. 6 illustrates an example of a process flow that supports techniques for predicting beams and/or beamforming parameters using machine learning models.

FIGS. 7 and 8 illustrate block diagrams of devices that support techniques for predicting beams and/or beamforming parameters using machine learning models.

FIG. 9 illustrates a block diagram of a communications manager that supports techniques for predicting beams and/or beamforming parameters using machine learning models.

FIG. 10 illustrates a diagram of a system including a device that supports techniques for predicting beams and/or beamforming parameters using machine learning models.

FIGS. 11-13 illustrate flowcharts showing methods that support techniques for predicting beams and/or beamforming parameters using machine learning models.

Like reference numbers and designations in the various drawings indicate like elements.

### DETAILED DESCRIPTION

The following description is directed to some particular implementations for the purposes of describing innovative aspects of this disclosure. However, a person having ordinary skill in the art will readily recognize that the teachings herein can be applied in a multitude of different ways. The described implementations can be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G or 5G (New Radio (NR)) standards promulgated by the 3rd Generation Partnership Project (3GPP), among others. The described implementations can be implemented in any device, system or network that is capable of transmitting and receiving RF signals according to one or more of the following technologies or techniques: code division multiple access (CDMA), time division multiple access (TDMA), frequency division multiple access (FDMA), orthogonal FDMA (OFDMA), single-carrier FDMA (SC-FDMA), single-user (SU) multiple-input multiple-output (MIMO) and multi-user (MU) MIMO. The described implementations also can be implemented using other wireless communication protocols or RF signals suitable for use in one or more of a wireless personal area network (WPAN), a wireless local area network (WLAN), a wireless wide area network (WWAN), or an internet of things (IOT) network.

In some deployments, wireless communication devices (such as wireless fidelity (Wi-Fi) devices) may support multi-link operation (MLO) according to which the devices may communicate via multiple different links. For example, an access point (AP) multi-link device (MLD) may communicate with a non-AP MLD via a link in a 2.4 gigahertz (GHz) band, a link in a 5 GHz band, a link in a 6 GHz band, or any combination thereof. The 2.4, 5, and 6 GHz bands may generally be referred to as “sub-7” bands. In some systems, an AP MLD and a non-AP MLD may be capable of communication via one or more other radio frequency links, such as in the 45 GHz or 60 GHz bands, which may generally be referred to as non-sub-7 bands. Communication links in such higher frequency bands may provide relatively higher data rates or greater link diversity. However, communication over such links may present several challenges resulting from the higher frequencies used, which may hinder adoption of such links, which may, in turn, limit an achievable throughput or diversity of future systems. For example, the non-sub-7 bands, such as the 45 GHz and the 60 GHz bands, may be relatively more susceptible to propagation losses as compared to sub-7 bands. As such, beam training/refinement procedures may be used to identify beams in these higher frequency bands that are less susceptible to propagation losses. However, current techniques for beam training are primarily reactive, in that the wireless communication devices first wait for the quality of a current beam to degrade before determining to perform a new beam training procedure to identify another beam that will have a better quality. Such reactive techniques may result in less efficient and less reliable wireless communications before new beam training is performed, and may increase a latency of communications when new beam training procedures are performed.

Various aspects generally relate to techniques for predicting one or more beams or beamforming parameters in the context of a Wi-Fi communication system, and more specifically, to techniques for predicting beams or beamforming parameters using a machine learning model. In particular, aspects of the present disclosure are directed to techniques for using a machine learning model to predict whether, and if so when, a beam training procedure is expected to be performed between Wi-Fi devices, and to predict beams (for example, transmit (Tx) beams and/or receive (Rx) beams) or beamforming parameters (for example, angle of arrival (AoA), steering angle, transmit sector identifier (TxSID), and receive sector identifier (RxSID)) that are expected/predicted to exhibit some threshold level of performance for future communications between the Wi-Fi devices. For example, a wireless station (STA) and/or an AP may determine one or more beamforming parameters associated with communications with one another, such as an AoA, a steering angle, a TxSID, and/or an RxSID, among other examples. In such examples, the STA, the AP, or both, may input the beamforming parameters into a machine learning model to predict beamforming parameters (for example, future AoAs/steering angles, future Tx/RxSIDs) for communications between the devices. Additionally, the machine learning model may predict whether one or more currently-used beams or beamforming parameters will have sufficient quality to be used for future communications, or whether new beam training procedures are expected to be, will be, or should be performed to identify one or more new beams or beamforming parameters that will be used for future communications between the devices. As such, wireless communication devices may utilize outputs from the machine learning model to determine whether or not to perform a new beam training procedure, and, if a beam training procedure is expected to be performed, what type or extent of beam training procedure should be performed (for example, more or less intensive beam training procedures).

Particular aspects of the subject matter described in this disclosure may be implemented to realize one or more of the following potential advantages. The techniques employed by the described communication devices may include proactive adaptation for beamforming parameters. For example, by using machine learning modeling to predict relative qualities of beams for future wireless communications, wireless communication devices may be able to proactively predict and select beamforming parameters that are expected to exhibit sufficient performance. As such, the use of machine learning models to perform beam and/or beamforming parameters prediction may facilitate more efficient and reliable communications between devices through more effective and efficient processes. Moreover, by enabling wireless communication devices to proactively predict beamforming parameters, and to predict if/when beamforming procedures are to be performed, wireless communication devices may be able to skip unnecessary beamforming procedures in some cases (such as when current beams are expected to exhibit high performance). Enabling wireless communication devices to skip unnecessary beamforming procedures may lead to a more efficient use of resources, and reduce a latency of communications between the respective devices.

Aspects of the disclosure are initially described in the context of a wireless communications system. Additional aspects of the disclosure are described in the context of an example machine learning model, an example communications configuration, and an example process flow. Aspects of the disclosure are further illustrated by and described with reference to apparatus diagrams, system diagrams, and flowcharts that relate to techniques for predicting beams and/or beamforming parameters using machine learning models

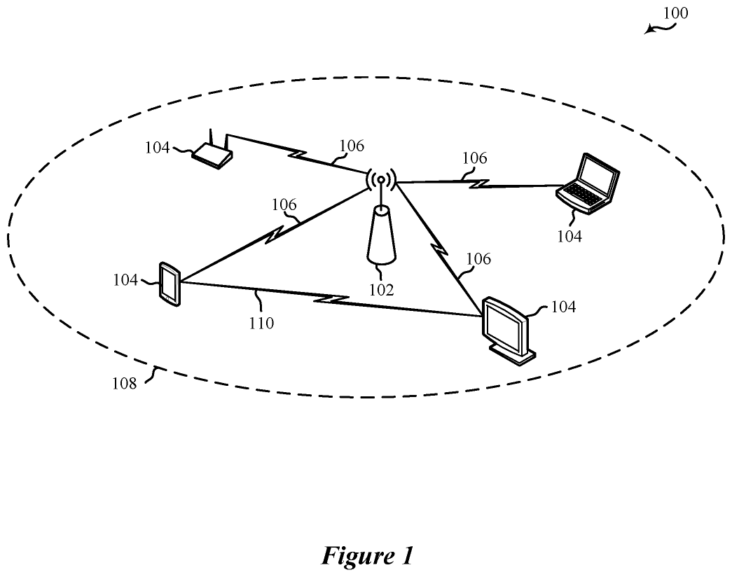

FIG. 1 shows a block diagram of an example wireless communication network 100. According to some aspects, the wireless communication network 100 can be an example of a WLAN such as a Wi-Fi network (and will hereinafter be referred to as WLAN 100). For example, the WLAN 100 can be a network implementing at least one of the IEEE 802.11 family of wireless communication protocol standards (such as that defined by the IEEE 802.11-2016 specification or amendments thereof including, but not limited to, 802.11ay, 802.11ax, 802.11az, 802.11ba and 802.11be). The WLAN 100 may include numerous wireless communication devices such as an access point (AP) 102 and multiple stations (STAs) 104. While only one AP 102 is shown, the WLAN 100 also can include multiple APs 102.

Each of the STAs 104 also may be referred to as a mobile station (MS), a mobile device, a mobile handset, a wireless handset, an access terminal (AT), a user equipment (UE), a subscriber station (SS), or a subscriber unit, among other possibilities. The STAs 104 may represent various devices such as mobile phones, personal digital assistant (PDAs), other handheld devices, netbooks, notebook computers, tablet computers, laptops, display devices (for example, TVs, computer monitors, navigation systems, among others), music or other audio or stereo devices, remote control devices (“remotes”), printers, kitchen or other household appliances, key fobs (for example, for passive keyless entry and start (PKES) systems), among other possibilities.

A single AP 102 and an associated set of STAs 104 may be referred to as a basic service set (BSS), which is managed by the respective AP 102. FIG. 1 additionally shows an example coverage area 106 of the AP 102, which may represent a basic service area (BSA) of the WLAN 100. The BSS may be identified to users by a service set identifier (SSID), as well as to other devices by a basic service set identifier (BSSID), which may be a medium access control (MAC) address of the AP 102. The AP 102 periodically broadcasts beacon frames (“beacons”) including the BSSID to enable any STAs 104 within wireless range of the AP 102 to “associate” or re-associate with the AP 102 to establish a respective communication link 108 (hereinafter also referred to as a “Wi-Fi link”), or to maintain a communication link 108, with the AP 102. For example, the beacons can include an identification of a primary channel used by the respective AP 102 as well as a timing synchronization function for establishing or maintaining timing synchronization with the AP 102. The AP 102 may provide access to external networks to various STAs 104 in the WLAN via respective communication links 108.

To establish a communication link 108 with an AP 102, each of the STAs 104 is configured to perform passive or active scanning operations (“scans”) on frequency channels in one or more frequency bands (for example, the 2.4 GHz, 5 GHz, 6 GHz or 60 GHz bands). To perform passive scanning, a STA 104 listens for beacons, which are transmitted by respective APs 102 at a periodic time interval referred to as the target beacon transmission time (TBTT) (measured in time units (TUs), and one TU may be equal to 1024 microseconds (μs)). To perform active scanning, a STA 104 generates and sequentially transmits probe requests on each channel to be scanned and listens for probe responses from APs 102. Each STA 104 may be configured to identify or select an AP 102 with which to associate based on the scanning information obtained through the passive or active scans, and to perform authentication and association operations to establish a communication link 108 with the selected AP 102. The AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA or to select among multiple APs 102 that together form an extended service set (ESS) including multiple connected BSSs. An extended network station associated with the WLAN 100 may be connected to a wired or wireless distribution system that may allow multiple APs 102 to be connected in such an ESS. As such, a STA 104 can be covered by more than one AP 102 and can associate with different APs 102 at different times for different transmissions. Additionally, after association with an AP 102, a STA 104 also may be configured to periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some cases, STAs 104 may form networks without APs 102 or other equipment other than the STAs 104 themselves. One example of such a network is an ad hoc network (or wireless ad hoc network). Ad hoc networks may alternatively be referred to as mesh networks or peer-to-peer (P2P) networks. In some cases, ad hoc networks may be implemented within a larger wireless network such as the WLAN 100. In such implementations, while the STAs 104 may be capable of communicating with each other through the AP 102 using communication links 108, STAs 104 also can communicate directly with each other via direct wireless links 110. Additionally, two STAs 104 may communicate via a direct wireless link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless links 110 include Wi-Fi Direct connections, connections established by using a Wi-Fi Tunneled Direct Link Setup (TDLS) link, and other P2P group connections.

The APs 102 and STAs 104 may function and communicate (via the respective communication links 108) according to the IEEE 802.11 family of wireless communication protocol standards (such as that defined by the IEEE 802.11-2016 specification or amendments thereof including, but not limited to, 802.11 ay, 802.11 ax, 802.11az, 802.11ba and 802.11be). These standards define the WLAN radio and baseband protocols for the PHY and medium access control (MAC) layers. The APs 102 and STAs 104 transmit and receive wireless communications (hereinafter also referred to as “Wi-Fi communications”) to and from one another in the form of PHY protocol data units (PPDUs) (or physical layer convergence protocol (PLCP) PDUs). The APs 102 and STAs 104 in the WLAN 100 may transmit PPDUs over an unlicensed spectrum, which may be a portion of spectrum that includes frequency bands traditionally used by Wi-Fi technology, such as the 2.4 GHz band, the 5 GHz band, the 60 GHz band, the 3.6 GHz band, and the 900 MHz band. Some implementations of the APs 102 and STAs 104 described herein also may communicate in other frequency bands, such as the 6 GHz band, which may support both licensed and unlicensed communications. The APs 102 and STAs 104 also can be configured to communicate over other frequency bands such as shared licensed frequency bands. Multiple operators may have a license to operate in the same or overlapping frequency band or bands.

Each of the frequency bands may include multiple sub-bands or frequency channels. For example, PPDUs conforming to the IEEE 802.11n, 802.1 lac, 802.1 lax and 802.11be standard amendments may be transmitted over the 2.4, 5 GHz or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 or 320 MHz by bonding together multiple 20 MHz channels.

Each PPDU is a composite structure that includes a PHY preamble and a payload in the form of a PHY service data unit (PSDU). The information provided in the preamble may be used by a receiving device to decode the subsequent data in the PSDU. In instances in which PPDUs are transmitted over a bonded channel, the preamble fields may be duplicated and transmitted in each of the multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is based on the particular IEEE 802.11 protocol to be used to transmit the payload.

The respective devices of the WLAN 100 may support techniques for predicting beams and/or beamforming parameters (for example, Tx/Rx beams, whether or not beam training is to be performed) using machine learning models. For example, an STA 115 and/or AP 105 of the WLAN 100 may determine parameters for communicating between the devices, such as AoAs, steering angles, TxSIDs, RxSIDs, among other examples. In such cases, the STA 115, the AP 105, or both, may input the parameters into a machine learning model to predict future parameters (for example, future AoAs/steering angles, future Tx/RxSIDs) for communications between the devices. Additionally, or alternatively, the machine learning model may predict whether currently-used beams may be used for future communications, or whether new beam training procedures are expected to be, will be, or should be performed to identify beamforming parameters that will be used for future communications between the devices.

Techniques described herein may enable the wireless communication devices of the WLAN 100 to proactively determine and adapt beamforming parameters to be used for communications between the respective devices. For example, techniques described herein may enable wireless communication devices to proactively predict and select beamforming parameters that are expected to exhibit sufficient performance. As such, aspects of the present disclosure may facilitate more efficient and reliable communications between devices. Moreover, by enabling wireless communication devices to proactively predict beamforming parameters, and to predict if/when beamforming procedures are to be performed, techniques described herein may enable the wireless communication devices to skip unnecessary beamforming procedures in some cases (such as when current beams are expected to exhibit high performance), leading to a more efficient use of resources, and reducing a latency of communications between the respective devices.

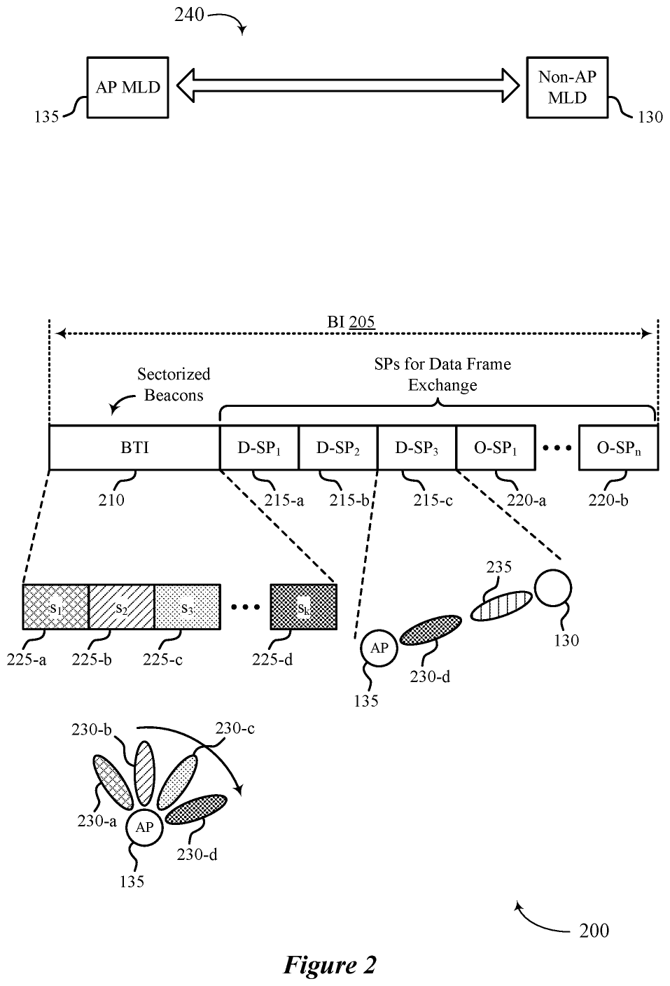

FIG. 2 illustrates an example of a wireless communications system 200 that supports techniques for predicting beams and/or beamforming parameters using machine learning models in accordance with one or more aspects of the present disclosure. Aspects of the wireless communications system 200 may implement, or be implemented by, aspects of the WLAN 100. For example, the wireless communications system 200 illustrates communication between a non-AP MLD 130 and an AP MLD 135, which may be examples of the non-AP MLD 130 and the AP MLD 135, respectively, as illustrated by and described with reference to FIG. 1.

In some implementations, the non-AP MLD 130 and the AP MLD 135 may communicate via a communication link 240. In some implementations, the communication link 240 may include one or more different links. For example, in some implementations, the communication link 240 may include a first radio frequency link (for example, a sub-7 link such as any one or more of a 2.4 GHz link, a 5 GHz link, or a 6 GHz link) and a second radio frequency link (for example, a non-sub-7 link such as a 45 GHz link, or a 60 GHz link). In this example, the first radio frequency link (for example, sub-7 link) may support communications performed via the second radio frequency link (for example, non-sub-7 link). In other words, the first radio frequency link may serve as an anchor or stable link that is used to facilitate communications via the second radio frequency link.

Moreover, in some aspects, a 60 GHz link may be part of an MLO setup involving sub-7 link(s). In other words, the AP operating on 60 GHz may be affiliated with the AP MLD 135 that has at least one other AP operating on a sub-7 link. In some implementations, aspects of the present disclosure are directed to utilizing sub-7 links as anchor links to facilitate operations on 60 GHz links, and to reduce management frame overhead. Aspects of the present disclosure are directed to utilizing the MLO framework to facilitate operations on a non-sub-7 link, such as a 45 GHz or 60 GHz link.

In some wireless communications systems, wireless communications within a 60 MHz band may be performed within repeating beacon intervals (BIs), such as the BI 205 illustrated in FIG. 2. In some cases, an interval within the BI 205 may additionally or alternatively be referred to as an AP sector reference (ASR) transmission period (ATP). In some examples, each BI 205 may be divided into at least three parts: (1) a beacon transmit interval (BTI) (for example, BTI 210), (2) dedicated service periods (D-SP) (for example, D-SPs 215-a, 215-b, 215-c) and opportunistic service periods (O-SPs 220-a, 220-b). During the BTI 210, an AP 105, an AP MLD 135, or a personal basic service set control point (PCP) may transmit multiple directional beacons (for example, beacon frames). In some cases, information associated with the BI configuration (for example, ATP information) may be communicated via sub-7 links. For example, the wireless communication devices may exchange signaling indicating a communication configuration/structure of the BI 205, including a periodicity of BIs 205, offsets (for example, offsets of D-SPs 215), durations of the respective portions within the BI 205, among other examples. Moreover, in some cases, communications over sub-7 links may be used to turn off or otherwise disable the BTI 210/ATP portion of the BI 205.

Some radio frequency bands (such as a 45 GHz or 60 GHz band) may provide a large amount of communication resources (such as a large swath of spectrum) that communicating devices (such as Wi-Fi devices) may use. Operation on relatively higher radio frequency bands (such as 45 GHz or 60 GHz bands) may present several challenges at a device or system level, which may lead to a lack of widespread adoption of the 45 GHz or 60 GHz band for data communications.

For example, transmissions within 45 GHz or 60 GHz bands may suffer from high propagation loss (for example, high attenuation). As such, omnidirectional transmissions (for example, non-beamformed transmissions) will not allow for high communication ranges. As a result, wireless communication devices may perform directional transmissions to take advantage of beamforming antenna gains to form a narrow beam towards the intended peer device. Stated differently, wireless communication devices communicating within non-sub-7 bands may focus transmissions and receptions to narrow beams in order for the transmissions to reach the intended receivers.

Beam training procedures may be performed to identify narrow beams used to perform beamforming communications in a beamformed mode. During a beam training procedure, transmission/reception planes at a transmitting/receiving devices may be divided up into several sectors. The wireless communication devices may be configured to identify narrow Tx/Rx beams within a sector that will be used for beamformed communications. Some beam training procedures (for example, beam training procedures defined by 802.11ad/ay) may include two steps or phases: (1) a sector-level sweep (SLS) phase (for example, sector-level training procedure), and (2) a beam refinement phase (BRP) (for example, beam refinement procedure).

While the terms “SLS” and “BRP” (and like terms) are the terms used and defined in 802.11 ad/ay, it is noted herein that different terminology may be used to refer to the different steps of a beam training procedure. In particular, future generations of Wi-Fi may adopt different words or phrases that are used to refer to the respective steps of a beam training procedure. Moreover, future generations of Wi-Fi may include additional or alternative steps/phases of a beam training procedure. However, aspects of the present disclosure, which enable wireless communication devices to skip beam training procedures or perform less-intensive beam training procedures, may be implemented for both the current beam training framework, as well as future beam training framework with additional and/or alternative steps/phases.

During an SLS phase of a beam training procedure, each device may take turns to transmit a frame (for example, ASR frame) within beam training resources 225-a, 225-b, 225-c, and 225-d on each of its sectors while the other device listens in quasi-omni state. The SLS phase may help establish an initial coarse-grain antenna sector configuration, which may be further refined during a subsequent BRP phase. For example, during the SLS phase, the AP MLD 135 may perform a sector sweep of (short) beacon frames during the BTI 210, as shown in FIG. 2. In particular, during the SLS phase, the AP-MLD 135 may sweep across sectors/beams 230 (beams 230-a, 230-b, 230-c, 230-d) while the non-AP MLD 130 listens using beams 235 (for example, quasi-omnidirectional or wide beams 235) to determine a general direction of the AP-MLD 135, and identify wide beams 235 that may be used to communicate with the AP-MLD 135 (for example, identify a sector corresponding to the AP-MLD 135). In other words, during SLS, the AP MLD 135 may take turns transmitting a short frame on each sector (for example, each beam 230), while the non-AP MLD 130 other side listens in a quasi-omnidirectional or omnidirectional mode to help establish a general direction of where the peer wireless communication device is located, and to use the received beacons/frames to evaluate whether additional beam training is used or not.

The short frames may include sector information (for example, beam 230 identifiers (IDs)) corresponding to the respective short frames. For instance, a short frame may include an ASR that acts as a reference for the non-AP MLD 130 to make beam training decisions. The ASR frame may include a BSSID and/or sector ID associated with the AP MLD 135. The short frames/ASR frames may additionally or alternatively include time synchronization function (TSF) information and a duration of the BI 205. In some cases, short frames/ASR frames may be similar to beacons, but may be shorter and may not include traditional elements such as traffic indication (TIM), Operational/Capabilities elements, reduced neighbor report (RNR) elements, and multi-link (ML) elements, among other examples. In such cases, the 60 GHz Operational or Capabilities information may be provided in a sub-7 link (for example, ML element), and traffic indications may be indicated at the MLD level (and provided in a sub-7 beacon(s)).

Comparatively, during the BRP (for example, beam refinement procedure) of the beam training procedure, the respective devices may exchange frames to fine-tune beams that were determined during SLS. As such, the BRP phase may be performed after the SLS phase, or may be performed without SLS in cases in which small adjustments to beams are expected or needed. In some cases, BRP may be combined with a data frame (for example, training sequence follows data). For example, during a BRP phase, the wireless communication devices sweep across narrow beams (for example, beams that are narrower than the wide beams 235 used in SLS) within the sector/wide beam 235 found during the SLS phase, and identify narrow beams within the identified sector/wide beam 235 that will be used to communicate with the peer device. In other words, the BRP may follow the SLS to further refine the beam information that will be used for wireless communications. Additionally, or alternatively, BRP may be performed independently (for example, without) the SLS to establish a narrow beam directed toward a peer device.

In this regard, depending on the degree of misalignment between beams at the AP-MLD 135 and the non-AP MLD 130, the devices may be configured to perform a full beam training procedure including SLS and BRP, or may be configured to perform a truncated or abbreviated beam training procedure including only BRP (for example, no SLS).

In some cases, the AP-MLD 135 and the non-AP MLD 130 may negotiate with one another to determine a configuration (for example, BI configuration) of one or more D-SPs 215 that may be used for communications between the respective devices. In some cases, D-SPs 215 may be configured for communications between the respective devices such that the D-SPs 215 do not overlap with one another in the time domain. Moreover, in cases in which the AP-MLD 135 is communicatively coupled to multiple clients (for example, multiple non-AP MLDs 130, multiple STAs), each respective non-AP MLD 130 may be configured with a separate set of D-SPs 215 (for example, each set of D-SPs 215 are dedicated to a single non-AP MLD 130). Moreover, in some cases, the AP-MLD 130 may activate or assign one or more O-SPs 220 (within a BI 205) to a client to perform additional communications (for example, flush pending buffer units) if the time allocated in the D-SP 215 was not sufficient to perform all buffered traffic that is to be exchanged between the respective devices (for example, because the AP-MLD 135 and non-AP MLD 130 needed to perform SLS and BRP during the D-SP 215).

Stated differently, short frames and/or ASR frames communicated during the SLS phase (for example, ATP) of a beam training procedure may enable the non-AP MLD 130 to obtain the TxSIDs associated with the AP MLD 135. Conversely, the AP MLD 135 may be configured to obtain the TxSID of the non-AP MLD 130 during the D-SPs 215, such as in the SLS or the BRP phase of a beam training procedure. In some cases, estimation of a TxSID associated with the non-AP MLD 130 may not be expected or required if there is limited or no mobility between the AP MLD 135 and non-AP MLD 130, and if the AP MLD 135 has a previous estimation of the TxSID associated with the non-AP MLD 130.

The beam training procedure illustrated in FIG. 2 may be used to illustrate beam training procedures performed between wireless communication devices following a new association, or a beam training procedure performed between wireless communication devices after one of the wireless communication devices has resumed after a long idle period. In particular, different steps of a beam training procedure (for example, SLS, BRP, or both) may be performed during different portions of the BI 205 illustrated in FIG. 2.

For example, in accordance with a first implementation, an STA (for example, non-AP MLD 130) may monitors several BTIs 210 in a quasi-omnidirectional mode to determine the general location of the AP MLD 135, and may performs responder-side SLS and BRP during an associated D-SP 215. In this regard, the AP MLD 135 may transmit signals as part of the SLS during the BTI(s) 210, the non-AP MLD 130 may transmit signals as part of the SLS during D-SPs 215, and the BRP is performed during the D-SP(s) 215. Stated differently, the non-AP MLD 130 may receive signals as part of the sector-level training procedure using a wide beam within one or more BTIs 210, and may transmit signals as part of the sector-level training procedure during one or more D-SPs 215. One drawback of this implementation is that the beam training procedure may take place over several BTIs 210, which may result in longer beam training. However, such delay may be acceptable for use cases that do not exchange frames on 60 GHz immediately after association.

By way of another example, in accordance with a second implementation, the AP MLD 135 and the non-AP MLD 130 (STA) may perform both SLS and BRP during the D-SP 215. In this implementation, a portion of the D-SP 215 (after association or after returning from idle state) may be used towards beam training.

As noted previously herein, communications over some radio frequency links may present several challenges, which may hinder adoption of such other radio frequency links (which may, in turn, limit an achievable throughput or diversity of a system). For example, the non-sub-7 bands, such as the 45 GHz and the 60 GHz bands, may be relatively more susceptible to propagation losses as compared to sub-7 bands. As such, beam refinement procedures may be utilized in sub-7 bands and in the 60 GHz band to identify beams within the respective bands that exhibit sufficient performance and are less susceptible to propagation loss. However, beamforming procedures (for example, beam training procedures) are complex and involve large signaling overhead. Additionally, beam directions between the devices may constantly change with small movements of the AP MLD 135, the non-AP MLD 130, or both. Further, current techniques for beam training are primarily reactive, in that wireless communication devices first wait for the quality of current beams to degrade (or when the link is completely lost) before determining to perform new beam training procedures. As such, current reactive techniques may result in less efficient and less reliable wireless communications before new beam training is performed, and may increase a latency of communications, loss of throughput, or both, when new beam training procedures are performed.

The respective devices of the wireless communications system 200 may be configured to support techniques for utilizing machine learning models to predict beamforming parameters. In particular, the respective devices (for example, AP MLD 135, non-AP MLD 130) of the wireless communications system 200 may be configured to input parameters (for example, Tx/Rx beams, Tx/RxSIDs, CSI/SNR/RSSI measurements) into a machine learning model that is configured to predict parameters associated with communications between the respective devices. For instance, the machine learning model may be configured to predict Tx/Rx beams that may be used for future wireless communications between the device, predict whether currently used beams can continue to be used (or how long the currently used beam may be used), predict whether the devices may perform a new beam training procedure (for example, SLS, or SLS+BRP), or any combination thereof.

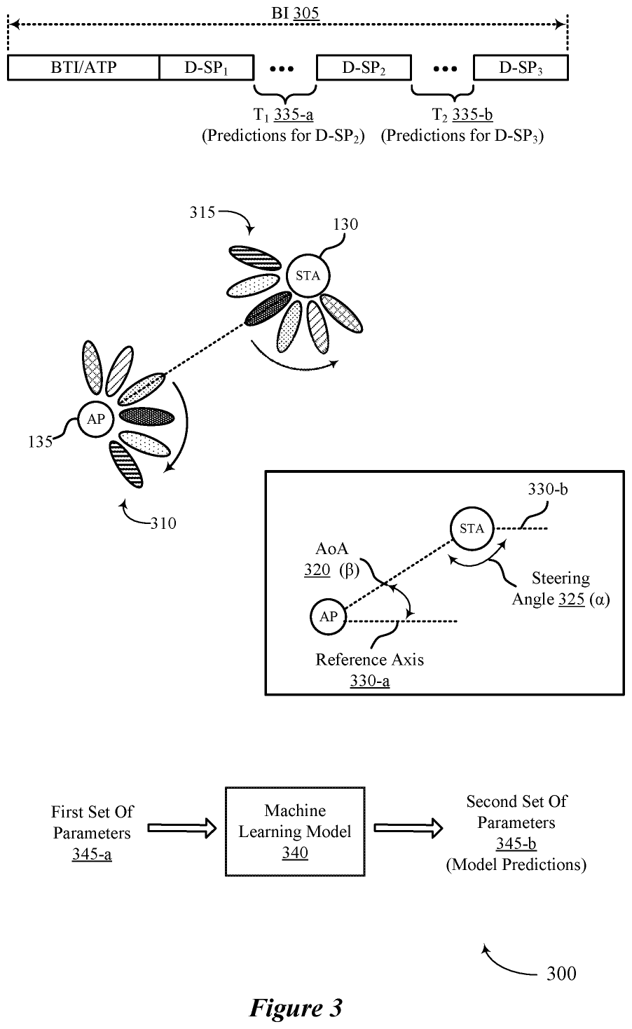

Attendant advantages of the techniques described herein may be further shown and described with reference to FIG. 3.

FIG. 3 illustrates an example of a wireless communications system 300 that supports techniques for predicting beams and/or beamforming parameters using machine learning models in accordance with one or more aspects of the present disclosure. Aspects of the wireless communications system 300 may implement, or be implemented by, aspects of the WLAN 100, the wireless communications system 200, or both. For example, the wireless communications system 300 illustrates communication between a non-AP MLD 130 (for example, STA) and an AP MLD 135 (for example, AP), which may be examples of the non-AP MLD 130 and the AP MLD 135, respectively, as illustrated by and described with reference to FIGS. 1 and 2.

The wireless communications system 300 illustrates a BI 305 which may include a BTI/ATP and one or more D-SPs, which may be examples of corresponding resources shown in FIG. 2. As described previously herein, the AP MLD 135 and the non-AP MLD 130 may be configured to perform beam training procedures (for example, SLS, SLS+BRP) to identify beams 310, 315 that will be used for wireless communications between the respective devices. When performing beam training procedures and selecting beams 310, 315 that will be used for wireless communications, the wireless communication devices may determine one or more beamforming parameters, such as an AoA 320, a steering angle 325, TxSIDs, RxSIDs, among other examples.

As shown in FIG. 2, the AoA 320 may refer to the (local) angle at which a signal is received by an Rx device from a Tx device, and the steering angle 325 may refer to the (local) angle at which a signal is transmitted by a Tx device to the Rx device. In this regard, because each of the AP MLD 135 and the non-AP MLD 130 may each act as Tx and Rx devices, each of the respective devices may be associated with a respective AoA 320 and steering angle 325. The AOA 320 and steering angle 325 may include radial angles, azimuthal angles, or both. The TxSID refers to the ID of the sector that corresponds to the steering angle 325 (for example, Tx side), whereas the RxSID refers to the ID of the sector that corresponds to the AoA 320 (for example, Rx side).

The respective AoAs 320 and steering angles 325 may be measured relative to reference axes 330-a, 330-b at each of the respective devices. The reference axes 330 may not align with one another, and may not be known to the other of the respective devices. As such, the devices may be expected to communicate information associated with the reference axes 330 so that the devices can coordinate beam selection based on AoAs 320 and/or steering angles 325. In other words, if an Rx device knows the AoA 320, the Rx device may not be able to predict the steering angle 325 because the reference axes 330 at the respective devices may not be known, but calibration/coordination between the devices may be useful.

In the context of a beam training or beamforming procedure (for example, procedures defined in 11ad/11ay), the TxSID at the AP MLD 135 may be determined during the SLS phase of a beam training procedure, which is used to determine a coarse level direction for the beams 310, 315. Comparatively, the AoA 320 and the steering angle 325 may be determined during the BRP phase of a beam training procedure, which is used to fine-tune the beams 310, 315 which were determined during the SLS phase. The coarse beams 310, 315 may be determined/formed when TxSID and RxSID are chosen correctly but the AoA 320 and the steering angle 325 are not correctly chosen, whereas fine-tuned beams 310, 315 may be determined/formed when the AoA 320 and the steering angle 325 are determined/chosen correctly.

If the AoA 320 is known to the Tx/Rx devices, the RxSID is also known. Similarly, if the steering angle 325 is known to the Tx/Rx devices, the TxSID is also known. However, if only the RxSID or TxSID is known, then the wireless communication devices may be expected to perform BRP to fine-tune the beams 310, 315. In some cases, the orientations of the beams 310, 315 for the Tx and Rx directions may not be reciprocal. For example, if the highest-performing TxSID at the AP MILD 135 for downlink communications to the non-AP MLD 130 is TxSID=11, the highest-performing RxSID for uplink communications from the same non-AP MLD 130 may not be RxSID=11. This is because the parameters and antenna configuration for transmit and receive may not be the same at a respective device.

According to some aspects of the present disclosure, wireless communication devices (for example, AP MLD 135, non-AP MLD 130) may be configured to utilize one or more machine learning models 340 to predict one or more parameters (for example, second set of parameters 345-b) associated with future communications between the respective devices. Parameters (for example, second set of parameters 345-b) that may be predicted using machine learning models 340 may include, but are not limited to, future AoAs 320, future steering angles 325, future Tx/RxSIDs, RxSID, among other examples. Additionally, or alternatively, the second set of parameters 345 predicted by the machine learning model may include beam coherence or validity times (for example, the time duration for which a beam 310, 315 can be assumed to remain unchanged, or exhibit some threshold level of performance, in which the TxSID and RxSID will remain the same), future widths of beams 310, 315, decisions for beam management (for example, maintaining the last used beam, moving to a new beam, detecting changes in environment), subsets of sectors to sweep for a beam training procedure, decisions for beam management, or any combination thereof.

As noted previously herein, some techniques for beamforming in a Wi-Fi system are reactive, meaning that wireless communication devices evaluate or estimate current parameters/performance of beams 310, 315 used for wireless communications (for example, current AoA 320, current steering angle 325, current Tx/RxSIDs) to determine whether or not to perform new beam training procedures. For example, to estimate the current AoA 320 and/or RxSID, devices may perform a two-dimensional (2D) sector sweeping at the beginning of each D-SP, use ranging techniques (for example, 11az) to estimate the position of the non-AP MLD 130 with respect to other AP MLDs 135 to determine AoAs 320 (to triangulate the position of the non-AP MLD 130 relative to the AP MLD 135), use 60 GHz 11az protocols to estimate the AOA 320, among other examples. However, such reactive techniques may result in deteriorating performance of the link between the respective devices, which may result in increased latency, and poor quality communications.

Comparatively, aspects of the present disclosure are directed to techniques for using machine learning models 340 to proactively predict future parameters for future beamformed communications. In other words, the machine learning model 340 may be used to predict relative stability/quality metrics and/or coherence validity times of the beam 310, 315 for future communications. In this regard, the machine learning model 340 may be used to predict whether previously-established beams 310, 315 will still be valid (for example, exhibit some threshold level of performance) for the future communications, how long previously-established beams 310, 315 may be used for (for example, beam coherence/validity times), among other examples.

For example, using IEEE 802.11bf-based sensing (for example, WLAN sensing or DMG sensing) the wireless communication devices may identify changes in the network/environment (for example, first set of parameters 345-a may indicate changing network conditions, such as changing beam qualities, CSI/SNR measurements). Using these changes/first set of parameters 345-a, the machine learning model 340 may be used to predict potential changes to beam configurations (for example, predict the second set of parameters 345-b, which may include future predicted beam qualities, future predicted CSI/SNR measurements).

In some aspects, the machine learning model(s) 340 may be implemented by the non-AP MLD 130, the AP MLD 135, or both. Prediction of the same output (for example, TxSID) from the machine learning model 340 may use different models (including the model inputs) for the AP MLD 135 and the non-AP MLD 130. In some cases, the outputs from the model (for example, second set of parameters 345-b, such as predicted AoAs 320 and/or sector information) may be used by the respective devices to determine beam configurations for future communications (for example, determine beams 310, 315 for future communications, determine whether to perform additional beam training).

The attendant advantages of the techniques described herein may be demonstrated through multiple examples or implementations.

In accordance with a first implementation, the machine learning model 340 may be used for AoA 320 prediction at the Rx device (for example, non-AP MLD 130 and/or AP MLD 135). In accordance with the first implementation, one of the wireless communication devices may observe the AoA 320 at N discrete time steps or time intervals, and use the machine learning model 340 to predict the AoA 320 for K future time steps/time intervals using the N input time steps. In this example, the machine learning model 340 may include a long short-term memory (LSTM) regressor with N inputs and K outputs. For instance, the AP MLD 135 may measure AoA 320 values for N past time intervals, and use the N AoA 320 values as inputs to the machine learning model 340 (for example, first set of parameters include the N AoA 320 values). The time duration between each successive time interval/time step may be constant (for example, 10 ms) or varied. In this example, the output of the machine learning model 340 may include K future AoA 320 values for K future time intervals/time steps (for example, second set of parameters include the K future AoA 320 values).

In some aspects, the wireless communication device implementing the machine learning model 340 may estimate the N AoA 320 values during each D-SP, and store the series of N AoA 320 values in memory for inputting the stored values into the machine learning model 340. For instance, using four previous AoA 320 values for four previous time intervals/steps (for example, N=4), the wireless communication device may be configured to train the LSTM regressor (for example, machine learning model 340) to predict one future AoA 320 value for a future time interval/step (for example, N=1). However, the model may be trained to use any quantity of inputs (any value of N) to predict any quantity of outputs (any value of K). In some cases, the same machine learning model 340 may be used to predict other outputs, such as steering angles 325, TxSIDs, RxSIDs, among other examples. In such cases, instead of using past AoA 320 values, the model can take as input the values of past steering angles 325, past Tx/RxSIDs, among other examples.

In accordance with a second implementation, the machine learning model 340 may be used to predict TxSIDs at a respective device (for example, non-AP MLD 130 and/or AP MLD 135). In other words, the machine learning model 340 may predict which TxSID the respective device may use to perform future communications with the other respective device. In accordance with the second implementation, the non-AP MLD 130 may observe transmissions from the AP MLD 135 to the non-AP MLD 130 and/or other devices for L time slots/intervals, and may use the observations to predict the TxSID of the AP MLD 135 for future communications. In this example, the first set of parameters 345-a used as inputs to the machine learning model may include measurements (for example, average SNR, CSI, RSSI) at each antenna element for the L previous time slots/intervals. The time duration between each successive time slot/interval may be constant (for example, 1 ms) or varied. For instance, the non-AP MLD 130 may determine the average SNR at each antenna element by averaging the observed SNR over respective 1 ms time intervals. In this example, the machine learning model 340 may include a DNN with L*M inputs (for example, L measurements for each antenna element×M antenna elements). The k^{th} output of the machine learning model 340 may indicate the probability of TxSID being equal to k in the (L+1)^{th} future time interval.

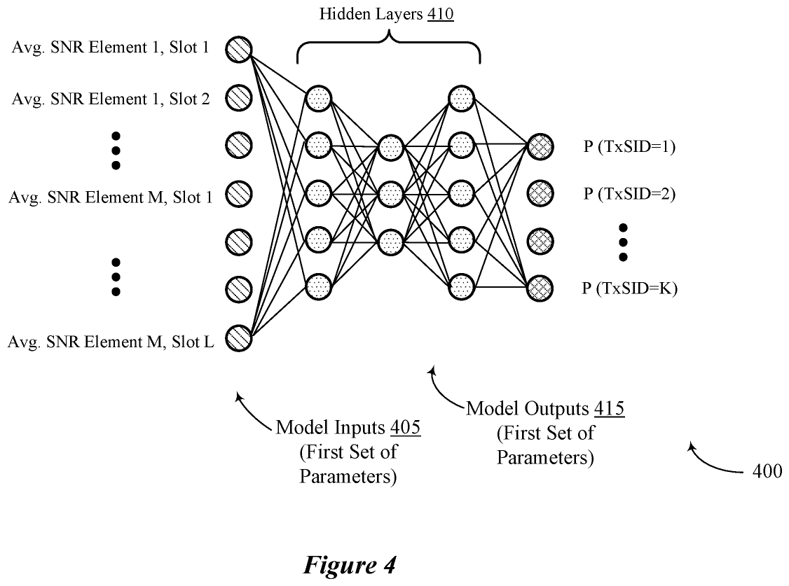

The second implementation may be further shown and described with reference to FIG. 4.

FIG. 4 illustrates an example of a machine learning configuration 400 that supports techniques for predicting beams and/or beamforming parameters using machine learning models in accordance with one or more aspects of the present disclosure. Aspects of the machine learning configuration 400 may implement, or be implemented by, aspects of the WLAN 100, the wireless communications system 200, the wireless communications system 300, or any combination thereof.

The machine learning configuration 400 may be an example of the machine learning model 340 illustrated in FIG. 3. The machine learning configuration 400 illustrates a set of model inputs 405 (for example, first set of parameters 345-a illustrated in FIG. 3), a set of hidden layers 410 (for example, convolutional neural network layers) of a machine learning model, and a set of model outputs 415 (for example, second set of parameters 345-b illustrated in FIG. 3).

Continuing with reference to the second implementation described above, the non-AP MLD 130 may wake up 5 ms before the start of each respective D-SP (for example, within time intervals 335-a, 335-b) to measure and store the average SNR at each antenna element for the 5 respective time intervals/steps of 1 ms each. The SNR measurements for the respective antenna elements within the respective time intervals prior to each D-SP may be used as the model inputs 405, as shown in FIG. 4. In this example, the model outputs 415 may include predicted probabilities or likelihoods that respective TxSIDs will exhibit a threshold performance, or predicted probabilities that the respective TxSIDs may be used for future communications (for example, the k^{th} model output 415 of the hidden layers 410/machine learning model 340 may indicate the probability of TxSID being equal to k in the (L+1)^{th} future time interval).

During the D-SP, non-AP MLD 130 may perform SLS+BRP with the AP MLD 135, and may and stores the TxSID as the label corresponding to the model output 415 labels. In other words, the non-AP MLD 130 may compare the TxSIDs used (or qualities of the TxSIDs) used for communications during the following D-SP to compare to the model outputs 415. In this example, the average SNR values observed during the time intervals/steps may be computed when the AP MLD 135 transmits PPDUs to other non-AP MLDs 130 in the network (for example, the non-AP MLD 130 may monitor communications from the AP MLD 135 to other devices to determine the SNR values uses as model inputs 405). In this regard, such a model may not be suitable for inference at the AP MLD 135 since non-AP MLD 130 typically does not transmit to other non-AP MLDs 130 in the network. However, if the AP MLD 135 is aware of an ongoing P2P transmissions between a first non-AP MLD 130 and a second non-AP MLD 130, the AP MLD 135 may observe transmissions from the first non-AP MLD 130 to the second non-AP MLD 130 and monitor the transmissions for determining the model inputs 405.

Reference will again be made to the wireless communications system 300 illustrated in FIG. 3.

In accordance with a third implementation, the machine learning model 340 may be used for fast beam reconfiguration. In particular, as the location of the non-AP MLD 130 and/or AP MLD 135 changes, the environment and relative positioning between the respective devices also changes, which may be detected by the machine learning model 340 to predict which beams 310, 315 may be used at the respective devices. For example, the non-AP MLD 130 and/or AP MLD 135 may estimate CSI between the respective devices (such as in a sub-7 link) immediately before each D-SP. The CSI measurements before each D-SP may be used as inputs (for example, first set of parameters 345-a) to the machine learning model 340. In this example, the machine learning model 340 may be configured to generate outputs (for example, second set of parameters 345-b) that are usable for determining a beamforming configuration for the subsequent D-SP. In other words, the devices may perform measurements in the time interval 335-a to use as inputs for predicting parameters for D-SP₁, and may perform measurements in the time interval 335-b to use as inputs for predicting parameters for D-SP₂.

In this example, the machine learning model 340 may utilize reinforcement learning, such as deep Q learning (DQN), and may utilize CSI measurements as inputs (for example, amplitude and phase information for all subcarriers). The CSI measurements used as the inputs/first set of parameters 345-b may be measured using WLAN sensing (for example, 11bf in sub-7 GHz bands). In this example, the output/second set of parameters 345-b (for example, Q values) may include any quantity of parameters/predictions. For example, the machine learning model 340 may indicate whether the devices may keep using the previously-established beams 310, 315 (for example, no SLS or BRP is used), whether the devices may keep using the previously-established sectors (for example, TxSID and RxSID), but perform BRP, an indication of a subset of sectors that may be swept across for a beam training procedure (for example, only sweep across the sectors 1 and 2, or only sweep across sectors 10 and 11), whether the devices may perform a full/complete sector sweep, whether the devices may switch to a different frequency band (for example, cease operation in 60 GHz when link breakdown is not due to mobility but due to blockage), among other examples.

In this regard, the preceding list of outputs/parameters of the machine learning model 340 may be regarded as the second set of parameters 345-b. Moreover, in some examples, the machine learning model 340 may output multiple of the outputs/parameters listed above, and may be configured to assign Q values to each of the output/parameters. In such examples, the respective devices and/or machine learning model 340 may be configured to select the parameter/output with the highest Q value, and may be configured to determine the beamforming configuration based on the selected output/parameter.

As shown in the various examples/implementations described above, the first set of parameters 345-a used as inputs to the machine learning model 340 may include a wide variety of parameters, characteristics, or measurements. Inputs to the machine learning model 340 may include one or more of following measurements/observations over an interval of time (for example, past values of): AoA 320 observations (for example, first implementation), steering angle 325 observations, TxSID and/or RxSID observations, SNR measurements at the antenna (or antenna elements) along different sectors (for example, second implementation), RSSI measurements at the antenna (or antenna elements) along different sectors, CSI measurements (for example, amplitude and phase values of channel gain of each tone) (for example, third implementation), channel impulse response measurements using DMG sensing, time of flight (or distance) measurements (for example, using 11az or 11bk ranging), external sensor measurements (for example, accelerometer, gyroscope, microphone, camera, infrared, ambient light) among other examples. Moreover, in some examples, a wireless communication device (for example, AP MLD 135) may receive parameters (for example, first set of parameters 345-a) from multiple other devices to perform predictions using the machine learning model 340.

The techniques described herein may be implemented to realize several advantages, including beamforming enhancements, scheduling enhancements, among other examples. Attendant advantages of the techniques described herein may be demonstrated via a series of examples.

In accordance with a first example, the AP MLD 135 may be configured to execute the machine learning model 340 that is configured to predict the AoA 320 or RxSID at the next D-SP. In some cases, the AP MLD 135 may perform predictions at the end of each current D-SP for the next D-SP. For example, the AP MLD 135 may predict the AoA 320 or RxSID for D-SP₁ during time interval 335-a, and may predict the AoA 320 or RxSID for D-SP₂ during time interval 335-b. In other words, the outputs (for example, second set of parameters 345-b) of the machine learning model 340 include: the angle R (for example, AoA 320), and that signals from the non-AP MLD 130 are to be received in a RxSID sector to maximize SNR.

In this example, the AP MLD 135 may transmit the predicted RxSID and/or predicted AoA 320 to the non-AP MLD 130. In some cases, the RxSID and/or AoA 320 information at the AP MLD 135 may not be directly useful to the non-AP MLD 130, but may be used as one of the inputs (for example, first set of parameters 345-a) by the non-AP MLD 130 when determining its own TxSID or steering angle 325. In other words, the outputs/second set of parameters 345-b from the AP MLD 135 may be used as inputs/first set of parameters 345-a for the non-AP MLD 130. The AP MLD 135 may use the predicted RxSID to determine a TxSID for future transmissions (for example, for future downlink communications in the following D-SP). The devices may select a beamforming configuration based on a degree of differences between the predicted parameters and the previous parameters. In some examples, if the predicted RxSID and/or AoA 320 is significantly different from the current RxSID/AoA 320, then the devices may select a beamforming configuration that causes the devices to perform beam training (for example, BRP for a first degree of change, or SLS+BRP for a second, greater degree of change between the predicted TxSID and/or AoA 320 and the current RxSID/AoA 320). In such cases, the AP MLD 135 may indicate for the devices to begin the following D-SP with beam training (for example, SLS or BRP). Such indications may be transmitted in a frame in the current D-SP or in another band.

In accordance with a second example, the AP MLD 135 may utilize the machine learning model 340 that is configured to predict the steering angle 325 and/or the TxSID at the non-AP MLD 130 for the following D-SP. In some cases, the AP MLD 135 may perform predictions at the end of each current D-SP for the next D-SP. For example, the AP MLD 135 may predict the steering angle 325 or TxSID for D-SP₁ during time interval 335-a, and may predict the steering angle 325 or TxSID during time interval 335-b. In other words, the outputs (for example, second set of parameters 345-b) of the machine learning model 340 include: the angle α (for example, steering angle 325), and that signals are to be transmitted by the non-AP MILD 130 in a TxSID sector to maximize SNR.

In this example, the AP MILD 135 may be configured to transmit the predicted steering angle 325 and/or TxSID to the non-AP MLD 130. Once again, in some examples, the non-AP MLD 130 may use indicated steering angle 325 and/or TxSID to determine (for example, through calibration or another machine learning model 340) its RxSID, and may monitor for frames from the AP MLD 135 on the determined RxSID. The AP MLD 135 may transmit the initial frame in the following D-SP in the indicated TxSID, and may configure itself in a quasi-omnidirectional mode to receive frames from the non-AP MLD 130. If the non-AP MLD 130 is aware of the TxSID at the AP MLD 135 (for example, from an indication received from the AP MLD 135, or through ASR), the non-AP MLD 130 may transmit the TxSID of the AP MLD 135 in the initial frame. The devices may select a beamforming configuration based on a degree of differences between the predicted parameters and the previous parameters. In some examples, if the predicted steering angle 325 and/or TxSID changes significantly from the previously-determined steering angle 325 and/or TxSID for the current D-SP, beam training (for example, BRP) may be used, and the devices may be configured to select a beamforming configuration that causes the devices to perform beam training (for example, BRP for a first degree of change, and SLS+BRP for a second, greater degree of change between the predicted steering angle 325 and/or TxSID and the previously-determined steering angle 325 and/or TxSID). In this regard, the AP MLD 135 may indicate for the devices to begin the following D-SP with SLS and/or BRP. Such indications may be transmitted in a frame in the current D-SP or in another band.

In accordance with a third example, the AP MLD 135 may utilize the machine learning model 340 that is configured to predict the AoA 320 and/or the RxSID (as described in the first example), the angle 325 and/or the TxSID (as described in the second example), or any combination thereof. As described above, the AP MLD 135 may report the outputs/second set of parameters 345-b to the non-AP MLD 130, which may use the reported parameters as inputs/first set of parameters 345-a for its own predictions. Moreover, the respective devices may utilize the predicted outputs (for example, second set of parameters 345-b including AoA 320, steering angle 325, RxSID, TxSID) for performing communications with one another in the following D-SP.

The devices may select a beamforming configuration based on a degree of differences between the predicted parameters and the previous parameters. In some examples, if both the AoA 320 and the steering angle 325 are predicted to remain unchanged, the devices may determine that no beam training is expected or required (for example, the second set of parameters 345-b may include an indication that no beam training is expected or required). As such, the AP MLD 135 indicate to begin the next D-SP with data frames (for example, no SLS or BRP is used). Comparatively, if the AoA 320 and the steering angle 325 are predicted to change, but the RxSID and/or TxSID are predicted to remain unchanged, the devices may determine that SLS is not to be used, but that BRP may be used (for example, the second set of parameters 345-b may include an indication that the devices are to perform BRP, but no SLS). As such, the AP MLD 135 may indicate to begin the next D-SP with BRP. If both the RxSID and the TxSID are predicted to change, the devices may determine that both SLS and BRP may be used (for example, the second set of parameters 345-b may include an indication that the devices are to perform BRP and SLS). In some examples, the devices may compare a change between the predicted parameters and the previous parameters to a threshold to determine whether to select a beamforming configuration associated with SLS, or BRP, or both.

In accordance with a fourth example, the AP MLD 135 and/or non-AP MLD 130 may be configured to execute the machine learning model 340 that is configured to predict beam stability (for example, a relative stability of the beam 310 and/or beam 315). In other words, the second set of parameters 345-b output from the model may include indications as to whether the devices are to continue using the same beams, whether beam training is or is not expected or required, whether the devices may perform a complete sector sweep, whether the devices may sweep across a sub-set of sectors (for example, only sweep across sectors adjacent to the previously-used beams/sectors), whether the devices may switch to a different frequency band, or any combination thereof. As noted previously herein, in some examples, the machine learning model 340 may determine/assign Q values for each of the outputs/second set of parameters 345-b, and the devices may be configured to select an action/beamforming configuration associated with the highest Q value.

If the selected parameter, action, or output (for example, parameter with highest Q-value) is to maintain the previously used beam, the respective device may indicate to begin the next D-SP directly with data frames (for example, no SLS or BRP is used). If the selected parameter/output is to perform complete sector sweep, the respective device may indicate to begin the next D-SP directly with SLS. If the selected parameter/output is to sweep only few sectors to the left/right of the last used beam 310, 315, the respective device may indicate the starting and ending sector IDs (for example, starting and ending TxSIDs and/or RxSIDs) for SLS. If the selected parameter/output is to cease operation in the 60 GHz band, the respective device may indicate for the devices to turn off their radios in the current band (for example, 60 GHz band) during the next D-SP, and/or tune radios to a different frequency band. In some aspects, the indications described above may be performed in-band (for example, within the 60 GHz band) and/or out-of-band (for example, within a sub-7 GHz band).

In accordance with a fifth example, the AP MLD 135 may execute the machine learning model 340 that is configured to predict beam coherence times (for example, validity times). As described previously herein, the terms “beam coherence times” and “validity times” may be used to refer to a time period or duration that a beam 310, 315 (for example, currently-used beam) and/or Tx/RxSID are expected to exhibit at least some threshold level of performance. As such, the beam coherence times/validity times may indicate how long the devices are expected to be able to use the current beams 310, 315.

For instance, if the AP MLD 135 predicts (using the machine learning model 340) that the TxSID and RxSID are expected to change across every D-SP, the beam coherence time/validity time may be less than the traffic periodicity. If the periodicity of traffic is greater than the beam coherence time/validity time, the AP MLD 135 may indicate for the devices to move communications to a different band, such as a sub-7 GHz band. The indication may be through a link recommendation frame, and may be transmitted on the sub-7 GHz band. In this example, the devices may enter the doze state on the 60 GHz band, and operate on the sub-7 GHz bands. Moreover, in some examples, the AP MLD 135 may determine the O-SP assignment for the non-AP MLD 130 based on the predicted coherence/validity time. In this example, the AP MLD 135 may assign an O-SP soon after the D-SP if the beam coherence/validity time is small, but may assign an O-SP far ahead in time if the beam coherence time is large.

In accordance with a seventh example, the AP MLD 135 may be configured to execute the machine learning model 340 that is configured to predict/determine a degree of mobility associated with the AP MLD 135, the non-AP MLD 130, or both. In other words, the second set of parameters 345-b output from the model may include mobility metric(s) for the respective devices. For the purposes of the present disclosure, the terms “degree of mobility,” “mobility metric,” and like terms, may be used to refer to a relative level of predicted or expected movement or mobility of a device. In this regard, devices that move more readily/frequently may exhibit higher mobility metrics, whereas devices that are more stationary may exhibit lower mobility metrics. In scenarios in which the machine learning model 340 predicts low mobility metrics (for example, static settings with little movement at/between the devices), the AP MLD 135 may determine not to send ASR (or Beacon) frames, which may be beneficial in P2P use cases to conserve power at the AP MLD 135. Comparatively, in scenarios in which the machine learning model 340 predicts medium or high mobility metrics (for example, dynamic settings with more movement at/between the devices), the AP MLD 135 may determine to change a width of its beam 310 used to perform transmissions in order to avoid frequent beam training.

In some aspects, predictions and/or exchange of predicted values (for example, second set of parameters 345-b output from the model, such as predicted mobility metrics) may be used for enhanced beam management in scenarios in which users or devices make movements with some patterns, such as pedestrian movements (for example, walking along hallway), playing extended reality (XR) games, delivery robots in warehouses, equipment in a factory production line, among other examples.

While the previous examples have primarily been described in the context of the AP MLD 135 implementing the machine learning model 340 to perform predictions, this is not to be regarded as a limitation of the present disclosure, unless noted otherwise herein. In particular, the non-AP MLD 130 may additionally or alternatively be configured to perform the predictions described in the examples described above. As such, the respective examples provided above may be implemented in reverse, in which the non-AP MLD 130 executes the machine learning model 340, and reports predictions to the AP MLD 135.

For instance, referring again to the sixth example above, the non-AP MLD 130 may be configured to execute the model that is configured to predict beam coherence/validity times. In such cases, the non-AP MLD 130 may report predicted beam coherence/validity times to the AP MLD 135 so that the AP MLD 135 can use this information when making scheduling decisions. Moreover, the non-AP MLD 130 may elect to enter into doze state if beam coherence time is less than its traffic periodicity.

In some aspects, the network, the AP MLD 135, the non-AP MLD 130, or any combination thereof, may offer trained machine learning models 340 that devices within the network may download and use for predicting parameters associated with beamforming procedures. For example, the AP MLD 135 may offer downloadable beamforming prediction models (for example, machine learning models 340) to associated non-AP MLDs 130 that support machine learning models 340 for beamforming prediction use cases. In some aspects, respective devices may provide feedback regarding the performance of the received machine learning models 340. Based on such feedback, the network (or other device which provided the trained model) may initiate the exchange of an alternative machine learning model 340, or disable the use case of the model for the device which provided the feedback (or entire BSS, if useful).

Moreover, in some examples, outputs from the machine learning model 340 (for example, second set of parameters 345-b), additional measurements performed by the devices, or both, may be used to further train the machine learning model 340. For example, in some cases, the second set of parameters 345-b may include predicted CSI values for different beams 310, 315, or predicted CSI values for a single beam 310, 315 at multiple time intervals in the future. In this example, the wireless communication devices may perform CSI measurements using the predicted beam(s) 310, 315, and may input the CSI measurements and/or the predicted CSI measurements back into the machine learning model 340 to further train the model. In this regard, the machine learning model 340 may be configured to compare the precited CSI measurements with the “actual” CSI measurements to further improve the ability of the model to perform CSI predictions going forward.

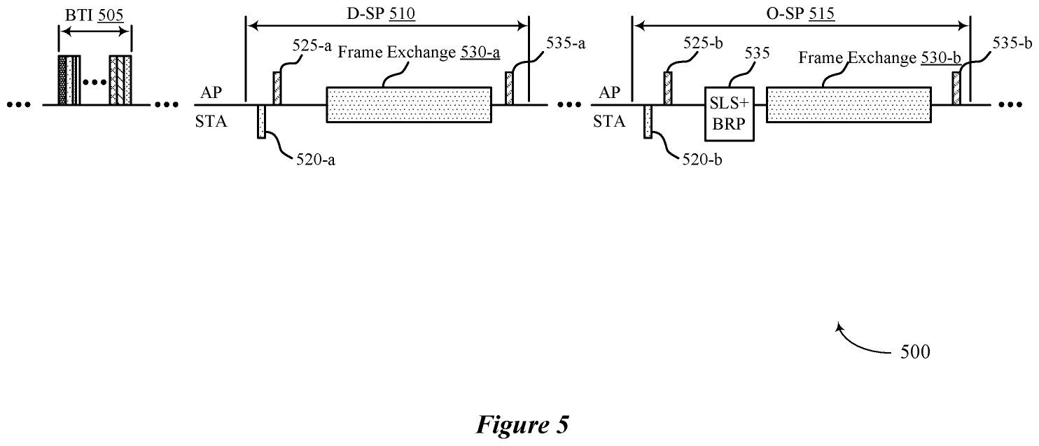

FIG. 5 illustrates an example of a communications configuration 500 that supports techniques for predicting beams and/or beamforming parameters using machine learning models in accordance with one or more aspects of the present disclosure. Aspects of the communications configuration 500 may implement, or be implemented by, aspects of the WLAN 100, the wireless communications system 200, the wireless communications system 300, the machine learning configuration 400, or any combination thereof.

As noted previously herein, a BI (for example, BI configuration) may include a BTI 505, one or more D-SPs 510, and one or more O-SPs 515. D-SPs 510 may include time intervals or durations which are reserved for serving a single non-AP MLD 130. The D-SPs 510 may be used to perform additional beam training subsequent to beam training performed in the BTI 505 (if useful), and may be used for frame exchange (for example, communications) between the respective devices. In some aspects, negotiations for the BI configuration (for example, service period negotiations) and scheduling updates may be performed on a sub-7 link. For example, a non-AP MLD 130 may negotiate a configuration of service periods (for example, D-SPs 510, O-SPs 515) within the BI after association with an AP MLD 135 on a sub-7 link. In some aspects, the non-AP MLD 130 may set up more than one service period within the same BI (based on traffic conditions).

Comparatively, O-SPs 515 may include additional time intervals or durations which are configured, activated, or otherwise set aside by the AP MLD 135 to flush pending frames which could not be serviced/communicated during a D-SP 510. In other words, if wireless communication devices are unable to exchange all buffered communications during the D-SP 510, the AP MLD 135 and/or non-AP MLD 130 may trigger or activate the O-SP 515 so that the devices may continue to exchange buffered traffic. In other words, the AP MLD 135 may identify an O-SP 515 that may be used to resume frame exchange at the end of an on-going service period (for example, D-SP 510) if there are pending BUs for uplink or downlink. As such, O-SPs 515 may be dynamically assigned to a non-AP MLD 130. In some cases, the AP MLD 135 may set up or activate O-SPs 515 during times between consecutive D-SPs 510. The configuration/schedule of O-SPs 515 may be indicated or negotiated in a sub-7 link.

For example, in some aspects, an AP MLD 135 may transmit beacon frames within each sector (for example, using beams) during the BTI 505. In this example, a non-AP MLD 130 may monitor or listen for the beacon frames during the BTI 505, and receive a beacon frame with an RSRP or other measurement that satisfies (for example, is greater than) a threshold using a beam. In this regard, the respective devices may determine that Tx and Rx beams are sufficiently well aligned during BTI 505. As such, the respective devices may not be expected to perform a beam training procedure during a D-SP 510. In this regard, the non-AP MLD 130 may transmit an initiating frame 520-a towards the beginning of the D-SP 510, and the initiating frame 520-a may indicate that the non-AP MLD 130 is not requesting or triggering a beam training procedure during the D-SP 510 (for example, BRP performance=0). Similarly, the AP MLD 135 may transmit a response frame 525-a in response to the initiating frame 520-a, and the response frame may also indicate that the AP MLD 135 is not requesting or triggering a beam training procedure during the D-SP 510 (for example, BRP performance=0). The respective devices may refrain from performing a beam training procedure during the D-SP 510, and may communicate messages with one another during the frame exchange 530-a using the beams determined during the BTI 505.

In some cases, if the AP-MLD 135 and/or the non-AP MLD 130 has additional data to be sent that will not be able to be communicated during the frame exchange 530-a and/or D-SP 510, the respective devices may activate or trigger an additional service period (for example, O-SP 515) to continue communications. For example, as shown in FIG. 5, the AP MLD 135 may transmit a frame 535-a that activates, triggers, or otherwise indicates the O-SP 515 that may be used to perform additional communications between the respective devices.

However, in some cases, such as due to mobility of the non-AP MLD 130, the relative orientations of the non-AP MLD 130 and the AP MLD 135 may change within the BI (for example, during the D-SP 510), causing the beams at the respective devices to misalign. In such cases, initiating frame/response frame sequences at the beginning of each service period may enable the devices to adapt to the latest channel conditions. Moreover, the non-AP MLD 130, the AP MLD 135, or both, may be able to detect a misalignment based on the performance of a frame exchange during a previous SP, and trigger a new beam training (for example, based on RSSI, error rate, retry count, MCS, machine learning).

For example, over the course of the D-SP 510, the AP MLD 135, the non-AP MLD 130, or both, may detect a misalignment between the beams used to communicate with one another (for example, based on RSSI, error rate). In this example, an initiating frame 520-b, a response frame 525-b, or both, within the O-SP 515 may indicate that the respective device(s) is/are requesting to perform a new beam training procedure during the O-SP 515 (for example, BRP performance=1). Subsequently, the devices may perform a beam training procedure (for example, only BRP) during a time interval 535 to determine one or more new beams that will be used to perform communications during a frame exchange 530-b.

In some cases, if the AP-MLD 135 and/or the non-AP MLD 130 has additional data to be sent that will not be able to be communicated during the frame exchange 530-b and/or O-SP 515, the respective devices may activate or trigger an additional O-SP 515 to continue communications. For example, as shown in FIG. 5, the AP MLD 135 may transmit a frame 535-b that activates, triggers, or otherwise indicates an additional O-SP 515 that may be used to perform additional communications between the respective devices.

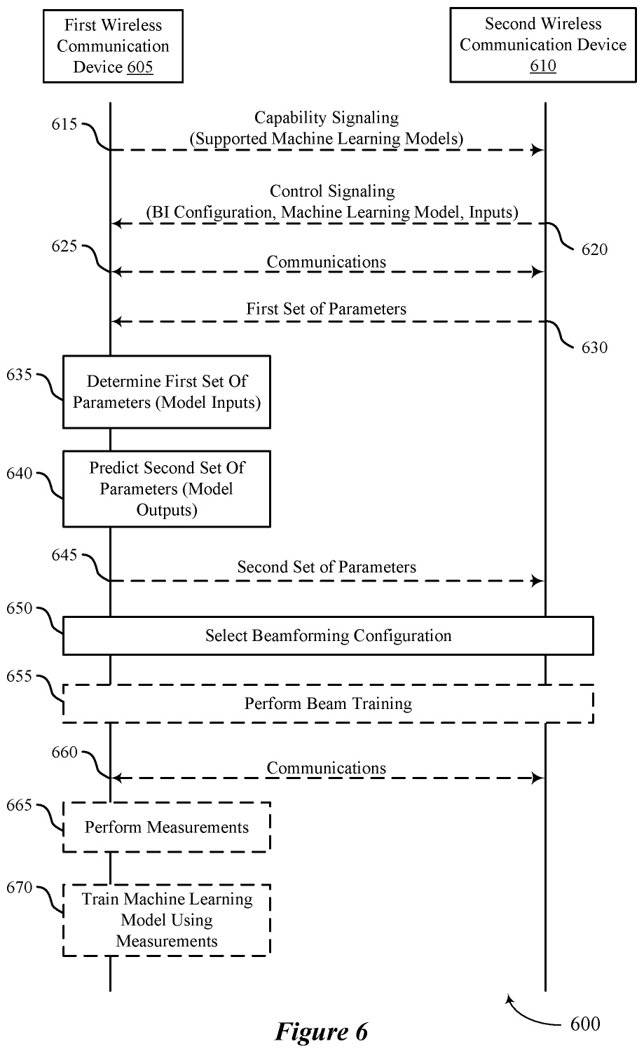

FIG. 6 illustrates an example of a process flow 600 that supports techniques for predicting beams and/or beamforming parameters using machine learning models in accordance with one or more aspects of the present disclosure. Aspects of the process flow 600 may implement, or be implemented by, aspects of the WLAN 100, the wireless communications system 200, the wireless communications system 300, the machine learning configuration 400, the communications configuration 500, or any combination thereof. For example, the process flow 600 illustrates signaling and techniques that enable wireless communication devices to predict beamforming parameters for future communications, as shown and described with respect to FIGS. 1-5.

The process flow 600 may include a first wireless communication device 605 and a second wireless communication device 610, which may be examples of non-AP MLDs 130, AP MLDs 135, STAs, and other wireless communication devices described with reference to FIGS. 1-5. For example, the first wireless communication device 605 and the second wireless communication device 610 illustrated in FIG. 6 may include examples of the non-AP MLD 130 and the AP MLD 135, respectively, as illustrated in FIGS. 2 and 3. Conversely, in other examples, the first wireless communication device 605 and the second wireless communication device 610 illustrated in FIG. 6 may include examples of the AP MLD 135 and the non-AP MLD 130, respectively, as illustrated in FIGS. 2 and 3.

In some examples, the operations illustrated in process flow 600 may be performed by hardware (for example, including circuitry, processing blocks, logic components, and other components), code (for example, software) executed by a processor, or any combination thereof. Alternative examples of the following may be implemented, in which some steps are performed in a different order than described or are not performed at all. In some cases, steps may include additional features not mentioned below, or further steps may be added.

At 615, the first wireless communication device 605 may transmit, to the second wireless communication device 610, capability signaling (for example, a capability message) indicating one or more capabilities associated with the first wireless communication device 605. For example, the capability signaling may indicate one or more machine learning models supported by the first wireless communication device 605, processing/memory capabilities, among other examples. Machine learning models may include, but are not limited to, time series-based prediction models, machine learning classifiers, reinforcement learning models, or any combination thereof.

At 620, the first wireless communication device 605 may receive control signaling from the second wireless communication device 610. The control signaling may indicate information associated with communications between the respective devices, machine learning models to be used for beamforming parameter prediction, communication parameters for communications between the devices, what types of inputs/outputs are to be used for machine learning models, among other examples.

For example, the control signaling may indicate a machine learning model from a set of machine learning models supported by the first wireless communication device 605, as indicated at 615. By way of another example, the control signaling may indicate a BI configuration (for example, a configuration/format of resources associated with the BI 205, 305), and the wireless communication devices may be configured to communicate with one another in accordance with the BI configuration (for example, within BTIs, D-SPs, and/or O-SPs associated with the BI configuration).

At 625, the first wireless communication device 605 and the second wireless communication device 610 may communicate with one another. The devices may communicate with one another at 625 based on the capability signaling at 615, the control signaling at 620, or both. For example, the wireless communication devices may communicate in accordance with the BI configuration indicated at 620.

In some cases, the wireless communication devices may communicate with one another in order to determine inputs (for example, first set of parameters 345-b) for the machine learning model. For example, in some cases, the wireless communication devices may perform measurements and/or determine beamforming parameters (for example, AoA, steering angle, TxSID, RxSID) based on the communications at 625. By way of another example, the first wireless communication device 605 may monitor communications exchanged between the second wireless communication device 610 and other wireless communication devices in order to determine a first set of parameters that are to be used as inputs for the machine learning model.

At 630, the first wireless communication device 605 may receive, from the second wireless communication device 610, a message indicating a first set of parameters (or a subset of the first set of parameters) that are to be used as inputs for the machine learning model. The devices may exchange the message at 630 based on the capability signaling at 615, the control signaling at 625, the communications at 625, or any combination thereof. For example, the message at 630 may indicate measurements performed by the second wireless communication device 610 (for example, current/past CSI, SNR, RSSI), beamforming parameters determined by the second wireless communication device 610 (for example, current/past AoA, steering angle, Tx/RxSID, beams), among other examples. The indicated measurements/parameters may be used as inputs for the machine learning model.

At 635, the first wireless communication device 605 may determine a first set of parameters that are to be used as inputs for the machine learning model. In this regard, the first set of parameters may be associated with a beamforming procedure (for example, beamformed communications) between the respective devices. The first wireless communication device 605 may determine the first set of parameters at 635 based on the capability signaling at 615, the control signaling at 625, the communications at 625, the message at 630, or any combination thereof. For example, in some cases, the first set of parameters may include CSI measurements performed by the first wireless communication device 605, and CSI measurements performed by the second wireless communication device 610 which were indicated at 630.

In some cases, the first wireless communication device 605 may determine the first set of parameters that will be used for model predictions for a following set of time intervals, such as a following D-SP. For example, as shown in FIG. 3, the first wireless communication device 605 may determine a first set of parameters associated with the time interval 335-a that will be used for the following D-SP₂. Similarly, by way of another example, the first wireless communication device 605 may determine a first set of parameters associated with the time interval 335-b that will be used for the following D-SP₃. As described previously herein, the first set of parameters used as inputs to the machine learning model may include, but are not limited to, current/past AoAs, current/past steering angles, current/past Tx/RxSIDs, current/past beams, current/past beam widths, current/past beam coherence/validity times, current/past channel quality metrics (for example, CSI, SNR, RSSI), current/past mobility metrics, among other examples.

At 640, the first wireless communication device 605 may predict a second set of parameters (for example, second set of parameters 345-b) associated with beamformed communications between the devices by inputting the first set of parameters (for example, first set of parameters 345-b) into the machine learning model. As noted previously herein, the second set of parameters may correspond to (for example, include predictions for) a set of future time intervals.

For example, as shown in FIG. 3, during the time interval 335-a, the first wireless communication device 605 may predict parameters associated with communications between the devices for the following D-SP₂. Similarly, during the time interval 335-b, the first wireless communication device 605 may predict parameters associated with communications between the devices for the following D-SP₃. In this example, the first sets of parameters 345-a used as inputs to the model may be associated with time periods/slots within the time intervals 335-a, 335-b, and the second sets of parameters 345-b used as outputs of the model may be associated with time periods/slots within the D-SPs.

As described previously herein, the second set of parameters used as outputs/predictions from the machine learning model may include, but are not limited to, future/predicted AoAs, future/predicted steering angles, future/predicted Tx/RxSIDs, future/predicted beams, future/predicted beam widths, future/predicted beam coherence/validity times, future/predicted channel quality metrics (for example, CSI, SNR, RSSI), future/predicted mobility metrics, among other examples. For example, in some cases, the second set of parameters may include indications as to whether the devices can continue to use the same beams and/or Tx/RxSIDs, whether the devices are expected to perform beam training (for example, full sector sweep, partial sector sweep, SLS, BRP, SLS+BRP), indications of beam coherence/validity times, among other examples. For instance, in some cases, the second set of parameters may include indications of subsets of beam sectors, subsets of beams, or both, that may be swept across during a beam training procedure between the devices. By way of another example, in some cases, the second set of parameters output from the model may include an indication that the devices may switch their communications to a different frequency band (for example, sub-7 band).

At 645, the first wireless communication device 605 may transmit a message to the second wireless communication device 610. The message may indicate at least a subset of the second set of parameters predicted at 640. In other words, the first wireless communication device 605 may report the predicted parameters to the second wireless communication device 610. In some examples, as described previously herein, reporting the second set of parameters to the second wireless communication device 610 may enable the second wireless communication device 610 to select a beamforming configuration (for example, beams, AoAs, steering angles, beam widths, Tx/RxSIDs) for future communications, and/or enable the second wireless communication device 610 to use the parameters as inputs to a model so that the second wireless communication device 610 can perform additional predictions.

At 650, the first wireless communication device 605, the second wireless communication device 610, or both, may select a beamforming configuration that will be used for beamformed communications between the respective devices. The devices may select the beamforming configuration at 650 based on predicting the second set of parameters at 640, transmitting/receiving the message at 645, or both. Selecting a beamforming configuration may include determining whether or not to perform a beam training procedure (for example, beamforming procedure), what type/extent of beam training to perform (for example, SLS, SLS+BRP, full sector sweep, partial sector sweep), determining what parameters to use for beamformed communications (for example, which beam, AoA, steering angle, TxSID, RxSID), or any combination thereof.

At 655, the first wireless communication device 605 and the second wireless communication device 610 may perform a beamforming procedure (for example, perform beam training). The devices may perform the beam training/beamforming at 655 based on predicting the second set of parameters at 640, transmitting/receiving the message at 645, selecting the beamforming configuration at 650, or any combination thereof. For example, the second set of parameters may include an indication that the devices may perform a new beamforming procedure, and the wireless communication devices may subsequently select a beamforming configuration that includes a beamforming procedure. In some cases, the second set of parameters may indicate what type or extent of beamforming procedure is to be performed (for example, SLS, BRP, SLS+BRP), what sectors may be swept for the beamforming procedure, among other examples.

In additional or alternative implementations, the wireless communication devices may refrain from performing beam training at 655 in cases in which the second set of parameters indicate that no beam training is used.

At 660, the wireless communication devices may communicate with one another. In particular, the wireless communication devices may communicate with one another based on (for example, in accordance with) the second set of parameters predicted at 640, the beamforming configuration selected at 650, or both. For example, in cases in which the second set of parameters include suggested beams and TxSID/RxSID for future time intervals (for example, a future D-SP), the wireless communication devices may communicate with another within the indicated time intervals (for example, within the D-SP) using the predicted beams and Tx/RxSIDs. Additionally, in cases in which the wireless communication devices perform beam training at 655, the wireless communication devices may communicate with one another in accordance with beams or parameters determined in accordance with the beam training.

At 665, the first wireless communication device 605 may perform measurements on signals received from the second wireless communication device 610 at 660. For example, the first wireless communication device 605 may perform CSI measurements, SNR measurements, RSSI measurements, or any combination thereof.

At 670, the first wireless communication device 605 may train the machine learning model by inputting the measurements performed at 665 into the machine learning model. In some cases, the first wireless communication device 605 may input the second set of parameters into the machine learning model along with the measurements in order to further train the model.

For example, in some cases, the second set of parameters predicted at 640 may include predicted CSI values for different beams (or predicted CSI values for a single beam) at multiple time intervals in the future. In this example, the first wireless communication device 605 may perform CSI measurements at 665 using the predicted beam(s), and may input the CSI measurements and/or the predicted CSI measurements back into the machine learning model to further train the model. In this regard, the machine learning model may be configured to compare the precited CSI measurements with the “actual” CSI measurements to further improve the ability of the model to perform CSI predictions going forward.

Techniques described herein may enable the wireless communication devices 605, 610 (for example, non-AP MLD 130, an AP MLD 135), non to proactively determine and adapt beamforming parameters to be used for communications between the respective devices. For example, techniques described herein may enable wireless communication devices to proactively predict and select beamforming parameters that are expected to exhibit sufficient performance. As such, aspects of the present disclosure may facilitate more efficient and reliable communications between devices. Moreover, by enabling wireless communication devices to proactively predict beamforming parameters, and to predict if/when beamforming procedures are to be performed, techniques described herein may enable the wireless communication devices to skip unnecessary beamforming procedures in some cases (such as when current beams are expected to exhibit high performance), leading to a more efficient use of resources, and reducing a latency of communications between the respective devices.

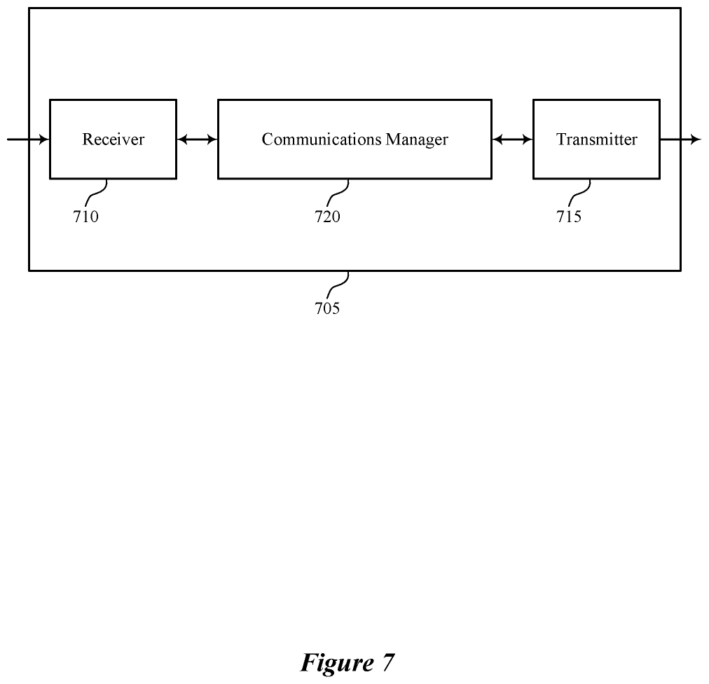

FIG. 7 illustrates a block diagram of a device 705 that supports techniques for predicting beams and/or beamforming parameters using machine learning models in accordance with one or more aspects of the present disclosure. The device 705 may be an example of aspects of an AP as described herein. The device 705 may include a receiver 710, a transmitter 715, and a communications manager 720. The communications manager 720 may be implemented, at least in part, by one or both of a modem and a processor. Each of these components may be in communication with one another (for example, via one or more buses).

The receiver 710 may provide a means for receiving information such as packets, user data, control information, or any combination thereof associated with various information channels (for example, control channels, data channels, information channels related to techniques for predicting beams and/or beamforming parameters using machine learning models). Information may be passed on to other components of the device 705. The receiver 710 may utilize a single antenna or a set of multiple antennas.

The transmitter 715 may provide a means for transmitting signals generated by other components of the device 705. The transmitter 715 may utilize a single antenna or a set of multiple antennas.

The communications manager 720, the receiver 710, the transmitter 715, or various combinations thereof or various components thereof may be examples of means for performing various aspects of techniques for predicting beams and/or beamforming parameters using machine learning models as described herein. For example, the communications manager 720, the receiver 710, the transmitter 715, or various combinations or components thereof may support a method for performing one or more of the functions described herein.

In some examples, the communications manager 720, the receiver 710, the transmitter 715, or various combinations or components thereof may be implemented in hardware (for example, in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (for example, by executing, by the processor, instructions stored in the memory).

Additionally, or alternatively, in some examples, the communications manager 720, the receiver 710, the transmitter 715, or various combinations or components thereof may be implemented in code (for example, as communications management software or firmware) executed by a processor. If implemented in code executed by a processor, the functions of the communications manager 720, the receiver 710, the transmitter 715, or various combinations or components thereof may be performed by a general-purpose processor, a DSP, a CPU, an ASIC, an FPGA, a microcontroller, or any combination of these or other programmable logic devices (for example, configured as or otherwise supporting a means for performing the functions described in the present disclosure).

In some examples, the communications manager 720 may be configured to perform various operations (for example, receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communication at a first wireless communication device in accordance with examples as disclosed herein. For example, the communications manager 720 may be configured as or otherwise support a means for determining a first set of parameters including parameters used within each time interval of a first set of time intervals for previous communications with a second wireless communication device, the first set of parameters associated with a beamforming procedure between the first wireless communication device and the second wireless communication device. The communications manager 720 may be configured as or otherwise support a means for predicting, after the first set of time intervals and in accordance with inputting the first set of parameters to a machine learning model, a second set of parameters corresponding to a second set of time intervals in the future. The communications manager 720 may be configured as or otherwise support a means for selecting a beamforming configuration for communications between the first wireless communication device and the second wireless communication device in accordance with the second set of parameters. The communications manager 720 may be configured as or otherwise support a means for communicating with the second wireless communication device within the second set of time intervals in accordance with the beamforming configuration.

By including or configuring the communications manager 720 in accordance with examples as described herein, the device 705 (for example, a processor controlling or otherwise coupled with the receiver 710, the transmitter 715, the communications manager 720, or a combination thereof) may support techniques that enable wireless communication devices (for example, non-AP MLD 130, an AP MLD 135), non to proactively determine and adapt beamforming parameters to be used for communications between the respective devices. For example, techniques described herein may enable wireless communication devices to proactively predict and select beamforming parameters that are expected to exhibit sufficient performance. As such, aspects of the present disclosure may facilitate more efficient and reliable communications between devices. Moreover, by enabling wireless communication devices to proactively predict beamforming parameters, and to predict if/when beamforming procedures are to be performed, techniques described herein may enable the wireless communication devices to skip unnecessary beamforming procedures in some cases (such as when current beams are expected to exhibit high performance), leading to a more efficient use of resources, and reducing a latency of communications between the respective devices.

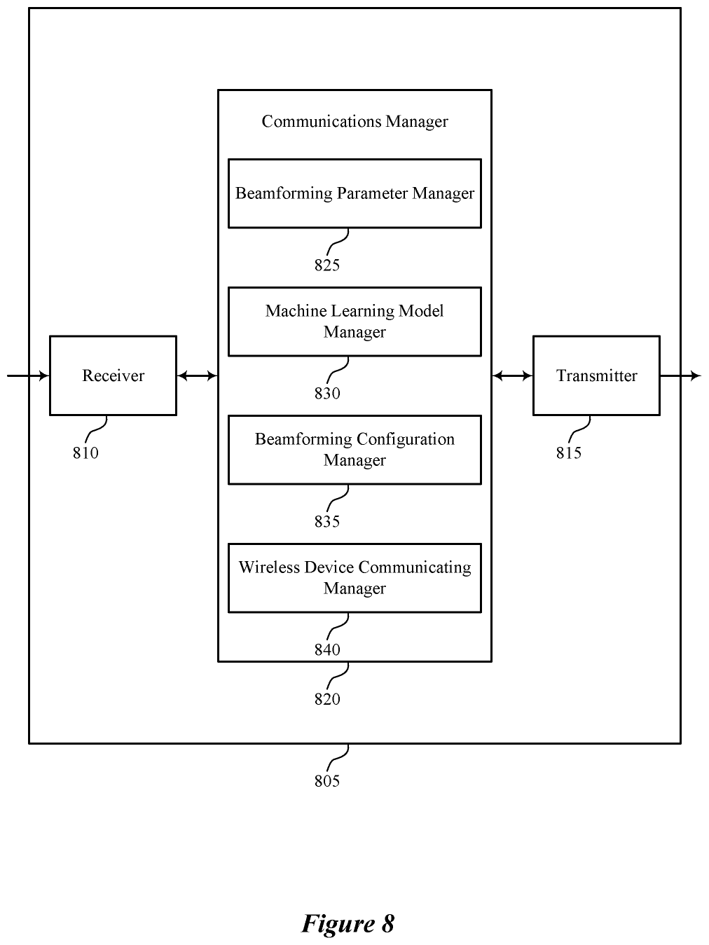

FIG. 8 illustrates a block diagram of a device 805 that supports techniques for predicting beams and/or beamforming parameters using machine learning models in accordance with one or more aspects of the present disclosure. The device 805 may be an example of aspects of a device 705 or an AP as described herein. The device 805 may include a receiver 810, a transmitter 815, and a communications manager 820. The communications manager 820 may be implemented, at least in part, by one or both of a modem and a processor. Each of these components may be in communication with one another (for example, via one or more buses).

The receiver 810 may provide a means for receiving information such as packets, user data, control information, or any combination thereof associated with various information channels (for example, control channels, data channels, information channels related to techniques for predicting beams and/or beamforming parameters using machine learning models). Information may be passed on to other components of the device 805. The receiver 810 may utilize a single antenna or a set of multiple antennas.

The transmitter 815 may provide a means for transmitting signals generated by other components of the device 805. The transmitter 815 may utilize a single antenna or a set of multiple antennas.

The device 805, or various components thereof, may be an example of means for performing various aspects of techniques for predicting beams and/or beamforming parameters using machine learning models as described herein. For example, the communications manager 820 may include a beamforming parameter manager 825, a machine learning model manager 830, a beamforming configuration manager 835, a wireless communication device communicating manager 840, or any combination thereof. In some examples, the communications manager 820, or various components thereof, may be configured to perform various operations (for example, receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communication at a first wireless communication device in accordance with examples as disclosed herein. The beamforming parameter manager 825 may be configured as or otherwise support a means for determining a first set of parameters including parameters used within each time interval of a first set of time intervals for previous communications with a second wireless communication device, the first set of parameters associated with a beamforming procedure between the first wireless communication device and the second wireless communication device. The machine learning model manager 830 may be configured as or otherwise support a means for predicting, after the first set of time intervals and in accordance with inputting the first set of parameters to a machine learning model, a second set of parameters corresponding to a second set of time intervals in the future. The beamforming configuration manager 835 may be configured as or otherwise support a means for selecting a beamforming configuration for communications between the first wireless communication device and the second wireless communication device in accordance with the second set of parameters. The wireless communication device communicating manager 840 may be configured as or otherwise support a means for communicating with the second wireless communication device within the second set of time intervals in accordance with the beamforming configuration.

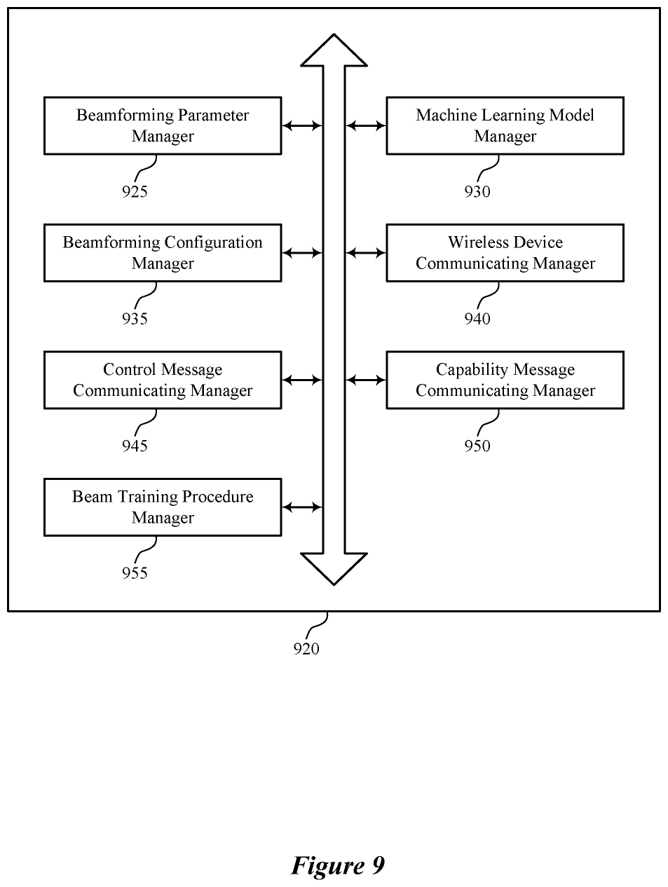

FIG. 9 illustrates a block diagram of a communications manager 920 that supports techniques for predicting beams and/or beamforming parameters using machine learning models in accordance with one or more aspects of the present disclosure. The communications manager 920, or various components thereof, may be an example of means for performing various aspects of techniques for predicting beams and/or beamforming parameters using machine learning models as described herein. For example, the communications manager 920 may include a beamforming parameter manager 925, a machine learning model manager 930, a beamforming configuration manager 935, a wireless communication device communicating manager 940, a control message communicating manager 945, a capability message communicating manager 950, a beam training procedure manager 955, or any combination thereof. Each of these components may communicate, directly or indirectly, with one another (for example, via one or more buses).

The communications manager 920 may support wireless communication at a first wireless communication device in accordance with examples as disclosed herein. The beamforming parameter manager 925 may be configured as or otherwise support a means for determining a first set of parameters including parameters used within each time interval of a first set of time intervals for previous communications with a second wireless communication device, the first set of parameters associated with a beamforming procedure between the first wireless communication device and the second wireless communication device. The machine learning model manager 930 may be configured as or otherwise support a means for predicting, after the first set of time intervals and in accordance with inputting the first set of parameters to a machine learning model, a second set of parameters corresponding to a second set of time intervals in the future after the first set of time intervals. The beamforming configuration manager 935 may be configured as or otherwise support a means for selecting a beamforming configuration for communications between the first wireless communication device and the second wireless communication device in accordance with the second set of parameters. The wireless communication device communicating manager 940 may be configured as or otherwise support a means for communicating with the second wireless communication device within the second set of time intervals in accordance with the beamforming configuration.

In some examples, determining the first set of parameters associated with the first set of time intervals includes communicating with the second wireless communication device via a first beam in accordance with the first set of parameters, and, to support predicting the second set of parameters, the machine learning model manager 930 may be configured as or otherwise support a means for predicting, using the machine learning model, an indication of whether the first beam is usable for communications with the second wireless communication device over the second set of time intervals, a validity time associated with a time duration that the first beam is usable for communications, or both, where the second set of parameters include the indication, the validity time, or both.

In some examples, the wireless communication device communicating manager 940 may be configured as or otherwise support a means for receiving, from the second wireless communication device, a message indicating the first set of parameters, where predicting the second set of parameters is associated with receiving the first set of parameters via the message.

In some examples, the wireless communication device communicating manager 940 may be configured as or otherwise support a means for transmitting, to the second wireless communication device, a second message indicating the second set of parameters, where selecting the beamforming configuration, communicating within the second set of time intervals, or both, is associated with transmitting the second message.

In some examples, the control message communicating manager 945 may be configured as or otherwise support a means for communicating, with the second wireless communication device, a control message indicating a beacon interval configuration including a set of multiple service periods usable for communications between the first wireless communication device and the second wireless communication device. In some examples, the wireless communication device communicating manager 940 may be configured as or otherwise support a means for monitoring for communications from the second wireless communication device within at least the first set of time intervals prior to a service period of the set of multiple service periods in accordance with the beacon interval configuration, where monitoring in accordance with the beacon interval configuration includes communicating within the service period including the second set of time intervals.

In some examples, the capability message communicating manager 950 may be configured as or otherwise support a means for communicating, with the second wireless communication device, a capability message indicating one or more machine learning models supported by the first wireless communication device, supported by the second wireless communication device, or both, the one or more machine learning models including the machine learning model, where predicting the second set of parameters is associated with the capability message.

In some examples, the wireless communication device communicating manager 940 may be configured as or otherwise support a means for communicating, with the second wireless communication device in accordance with the capability message, an additional message indicating one or more inputs to the machine learning model, where inputting the first set of parameters to the machine learning model is associated with the additional message.

In some examples, the beam training procedure manager 955 may be configured as or otherwise support a means for performing a sector-level sweep procedure, a beam refinement procedure, or both, with the second wireless communication device in accordance with the beamforming configuration, where communicating with the second wireless communication device in accordance with the beamforming configuration is associated with performing the sector-level sweep procedure, the beam refinement procedure, or both.

In some examples, to support performing the sector-level sweep procedure, the beam refinement procedure, or both, the beam training procedure manager 955 may be configured as or otherwise support a means for performing both the sector-level sweep procedure and the beam refinement procedure in accordance with the beamforming configuration and a difference between the second set of parameters and the first set of parameters being greater than a threshold difference.

In some examples, to support performing the sector-level sweep procedure, the beam refinement procedure, or both, the beam training procedure manager 955 may be configured as or otherwise support a means for performing the beam refinement procedure in accordance with the beamforming configuration and a difference between the second set of parameters and the first set of parameters being less than a threshold difference.

In some examples, to support predicting the second set of parameters, the machine learning model manager 930 may be configured as or otherwise support a means for predicting, using the machine learning model, a subset of the set of multiple beam sectors, a subset of the set of multiple beams, or both, that are to be used for wireless communications with the second wireless communication device, where the second set of parameters include indications of the subset of the set of multiple beam sectors, the subset of the set of multiple beams, or both, where the sector-level sweep procedure, the beam refinement procedure, or both, are performed across the subset of the set of multiple beam sectors, the subset of the set of multiple beams, or both.

In some examples, the first set of parameters, the second set of parameters, or both, include one or more of an angle of arrival of communications between the first wireless communication device and the second wireless communication device, a steering angle of communications between the first wireless communication device and the second wireless communication device, a TxSID or an RxSID associated with the first wireless communication device, the second wireless communication device, or both, a width of a beam used for communication by the first wireless communication device, the second wireless communication device, or both, a validity time associated with the beam used for communication by the first wireless communication device, the second wireless communication device, or both, or channel quality metrics associated with communications exchanged between the first wireless communication device and the second wireless communication device.

In some examples, the wireless communication device communicating manager 940 may be configured as or otherwise support a means for performing a set of measurements on communications performed within the second set of time intervals. In some examples, the machine learning model manager 930 may be configured as or otherwise support a means for training the machine learning model by inputting the second set of parameters, the set of measurements, or both, into the machine learning model.

In some examples, the wireless communication device communicating manager 940 may be configured as or otherwise support a means for communicating within the first set of time intervals within a first frequency band, where determining the first set of parameters is associated with communicating within the first frequency band, where predicting the second set of parameters includes predicting, using the machine learning model, a second frequency band for communications between the first wireless communication device and the second wireless communication device, where the second set of parameters include the second frequency band, and where communicating within the second set of time intervals is performed within the second frequency band.

In some examples, the first wireless communication device includes an STA, a first multi-link device, or both. In some examples, the second wireless communication device includes an AP, a second multi-link device, or both. In some examples, the first wireless communication device includes an AP, a first multi-link device, or both. In some examples, the second wireless communication device includes an STA, a second multi-link device, or both. In some examples, the first wireless communication device includes a first STA. In some examples, the second wireless communication device includes a second STA. In some examples, the machine learning model includes one or more of a time series-based prediction model, a machine learning classifier, or a reinforcement learning model.

In some examples, the control message communicating manager 945 may be configured as or otherwise support a means for receiving, from the second wireless communication device, a message indicating the machine learning model, where determining the first set of parameters, predicting the second set of parameters, or both, is based on receiving the message indicating the machine learning model.

In some examples, to support predicting the second set of parameters, the machine learning model manager 930 may be configured as or otherwise support a means for predicting, using the machine learning model, one or more mobility metrics associated with a relative level of mobility for the first wireless communication device, the second wireless communication device, or both, where the second set of parameters include the one or more mobility metrics.

In some examples, the beam training procedure manager 955 may be configured as or otherwise support a means for determining a frequency or periodicity of a set of multiple sectorized transmissions exchanged as part of the beamforming procedure between the first wireless communication device and the second wireless communication device in accordance with the second set of parameters, where the set of multiple sectorized transmissions include an ID associated with the first wireless communication device, an ID associated with a communication sector of the first wireless communication device, or both.

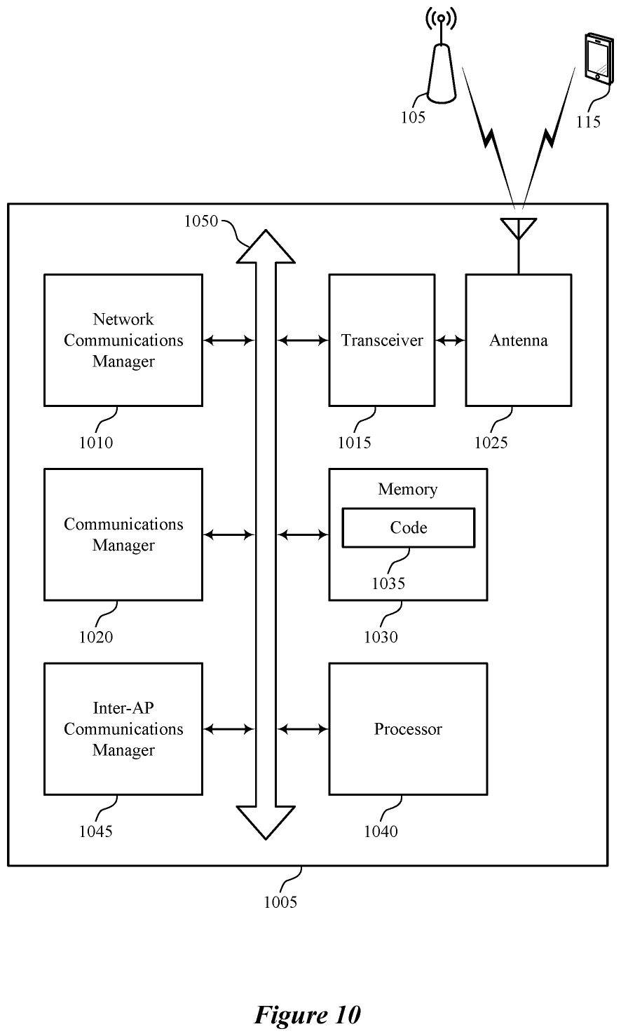

FIG. 10 illustrates a diagram of a system including a device 1005 that supports techniques for predicting beams and/or beamforming parameters using machine learning models in accordance with one or more aspects of the present disclosure. The device 1005 may be an example of or include the components of a device 705, a device 805, or an AP as described herein. The device 1005 may include components for bi-directional voice and data communications including components for transmitting and receiving communications, such as a communications manager 1020, a network communications manager 1010, a transceiver 1015, an antenna 1025, a memory 1030, code 1035, a processor 1040, and an inter-AP communications manager 1045. These components may be in electronic communication or otherwise coupled (for example, operatively, communicatively, functionally, electronically, electrically) via one or more buses (for example, a bus 1050).

The network communications manager 1010 may manage communications with a core network (for example, via one or more wired backhaul links). For example, the network communications manager 1010 may manage the transfer of data communications for client devices, such as one or more STAs 115.

In some cases, the device 1005 may include a single antenna 1025. However, in some other cases the device 1005 may have more than one antenna 1025, which may be capable of concurrently transmitting or receiving multiple wireless transmissions. The transceiver 1015 may communicate bi-directionally, via the one or more antennas 1025, wired, or wireless links as described herein. For example, the transceiver 1015 may represent a wireless transceiver and may communicate bi-directionally with another wireless transceiver. The transceiver 1015 may also include a modem to modulate the packets and provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The memory 1030 may include RAM and ROM. The memory 1030 may store computer-readable, computer-executable code 1035 including instructions that, when executed by the processor 1040, cause the device 1005 to perform various functions described herein. In some cases, the memory 1030 may contain, among other things, a BIOS, which may control basic hardware or software operation such as the interaction with peripheral components or devices.

The processor 1040 may include an intelligent hardware device, (for example, a general-purpose processor, a DSP, a CPU, a microcontroller, an ASIC, an FPGA, a programmable logic device, a discrete gate or transistor logic component, a discrete hardware component, or any combination thereof). In some cases, the processor 1040 may be configured to operate a memory array using a memory controller. In some other cases, a memory controller may be integrated into the processor 1040. The processor 1040 may be configured to execute computer-readable instructions stored in a memory (for example, the memory 1030) to cause the device 1005 to perform various functions (for example, functions or tasks supporting techniques for predicting beams and/or beamforming parameters using machine learning models). For example, the device 1005 or a component of the device 1005 may include a processor 1040 and memory 1030 coupled with or to the processor 1040, the processor 1040 and memory 1030 configured to perform various functions described herein.

The inter-station communications manager 1045 may manage communications with other APs 105, and may include a controller or scheduler for controlling communications with STAs 115 in cooperation with other APs 105. For example, the inter-station communications manager 1045 may coordinate scheduling for transmissions to APs 105 for various interference mitigation techniques such as beamforming or joint transmission. In some examples, the inter-station communications manager 1045 may provide an X2 interface within an LTE/LTE-A wireless communication network technology to provide communication between APs 105.

The communications manager 1020 may support wireless communication at a first wireless communication device in accordance with examples as disclosed herein. For example, the communications manager 1020 may be configured as or otherwise support a means for determining a first set of parameters including parameters used within each time interval of a first set of time intervals for communications with a second wireless communication device, the first set of parameters associated with a beamforming procedure between the first wireless communication device and the second wireless communication device. The communications manager 1020 may be configured as or otherwise support a means for predicting, after the first set of time intervals and in accordance with inputting the first set of parameters to a machine learning model, a second set of parameters corresponding to a second set of time intervals in the future. The communications manager 1020 may be configured as or otherwise support a means for selecting a beamforming configuration for communications between the first wireless communication device and the second wireless communication device in accordance with the second set of parameters. The communications manager 1020 may be configured as or otherwise support a means for communicating with the second wireless communication device within the second set of time intervals in accordance with the beamforming configuration.

By including or configuring the communications manager 1020 in accordance with examples as described herein, the device 1005 may support techniques that enable wireless communication devices (for example, non-AP MLD 130, an AP MLD 135), non to proactively determine and adapt beamforming parameters to be used for communications between the respective devices. For example, techniques described herein may enable wireless communication devices to proactively predict and select beamforming parameters that are expected to exhibit sufficient performance. As such, aspects of the present disclosure may facilitate more efficient and reliable communications between devices. Moreover, by enabling wireless communication devices to proactively predict beamforming parameters, and to predict if/when beamforming procedures are to be performed, techniques described herein may enable the wireless communication devices to skip unnecessary beamforming procedures in some cases (such as when current beams are expected to exhibit high performance), leading to a more efficient use of resources, and reducing a latency of communications between the respective devices.

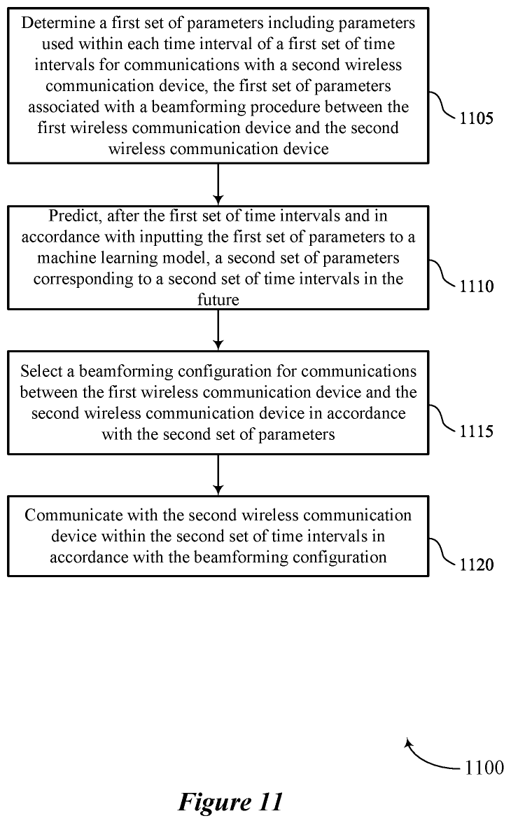

FIG. 11 illustrates a flowchart illustrating a method 1100 that supports techniques for predicting beams and/or beamforming parameters using machine learning models in accordance with one or more aspects of the present disclosure. The operations of the method 1100 may be implemented by an AP or its components as described herein. For example, the operations of the method 1100 may be performed by an AP as described with reference to FIGS. 1-10. In some examples, an AP may execute a set of instructions to control the functional elements of the AP to perform the described functions. Additionally, or alternatively, the AP may perform aspects of the described functions using special-purpose hardware.

At 1105, the method may include determining a first set of parameters including parameters used within each time interval of a first set of time intervals for communications with a second wireless communication device, the first set of parameters associated with a beamforming procedure between the first wireless communication device and the second wireless communication device. The operations of 1105 may be performed in accordance with examples as disclosed herein. In some examples, aspects of the operations of 1105 may be performed by a beamforming parameter manager 925 as described with reference to FIG. 9.

At 1110, the method may include predicting, after the first set of time intervals and in accordance with inputting the first set of parameters to a machine learning model, a second set of parameters corresponding to a second set of time intervals in the future. The operations of 1110 may be performed in accordance with examples as disclosed herein. In some examples, aspects of the operations of 1110 may be performed by a machine learning model manager 930 as described with reference to FIG. 9.

At 1115, the method may include selecting a beamforming configuration for communications between the first wireless communication device and the second wireless communication device in accordance with the second set of parameters. The operations of 1115 may be performed in accordance with examples as disclosed herein. In some examples, aspects of the operations of 1115 may be performed by a beamforming configuration manager 935 as described with reference to FIG. 9.

At 1120, the method may include communicating with the second wireless communication device within the second set of time intervals in accordance with the beamforming configuration. The operations of 1120 may be performed in accordance with examples as disclosed herein. In some examples, aspects of the operations of 1120 may be performed by a wireless communication device communicating manager 940 as described with reference to FIG. 9.

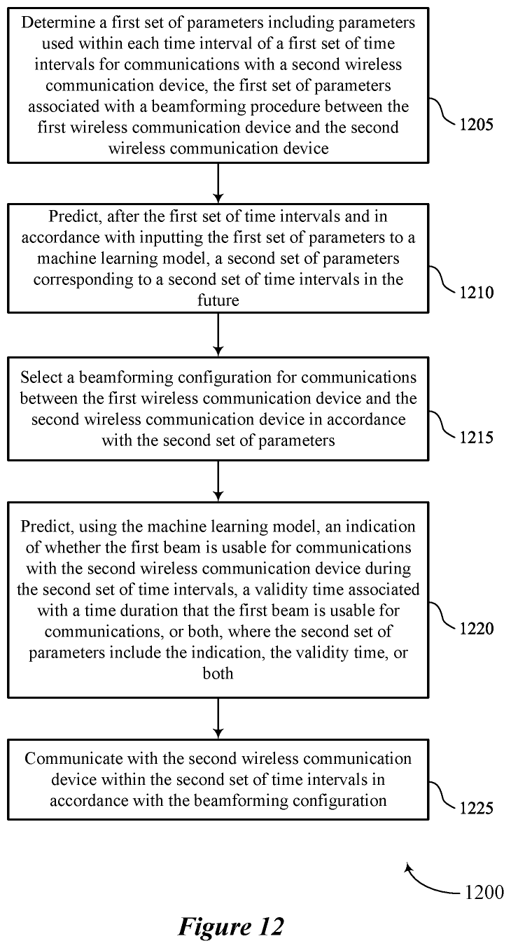

FIG. 12 illustrates a flowchart illustrating a method 1200 that supports techniques for predicting beams and/or beamforming parameters using machine learning models in accordance with one or more aspects of the present disclosure. The operations of the method 1200 may be implemented by an AP or its components as described herein. For example, the operations of the method 1200 may be performed by an AP as described with reference to FIGS. 1-10. In some examples, an AP may execute a set of instructions to control the functional elements of the AP to perform the described functions. Additionally, or alternatively, the AP may perform aspects of the described functions using special-purpose hardware.

At 1205, the method may include determining a first set of parameters including parameters used within each time interval of a first set of time intervals for communications with a second wireless communication device, the first set of parameters associated with a beamforming procedure between the first wireless communication device and the second wireless communication device. The operations of 1205 may be performed in accordance with examples as disclosed herein. In some examples, aspects of the operations of 1205 may be performed by a beamforming parameter manager 925 as described with reference to FIG. 9.

At 1210, the method may include predicting, after the first set of time intervals and in accordance with inputting the first set of parameters to a machine learning model, a second set of parameters corresponding to a second set of time intervals in the future. The operations of 1210 may be performed in accordance with examples as disclosed herein. In some examples, aspects of the operations of 1210 may be performed by a machine learning model manager 930 as described with reference to FIG. 9.

At 1215, the method may include selecting a beamforming configuration for communications between the first wireless communication device and the second wireless communication device in accordance with the second set of parameters. The operations of 1215 may be performed in accordance with examples as disclosed herein. In some examples, aspects of the operations of 1215 may be performed by a beamforming configuration manager 935 as described with reference to FIG. 9.

At 1220, the method may include predicting, using the machine learning model, an indication of whether the first beam is usable for communications with the second wireless communication device over the second set of time intervals, a validity time associated with a time duration that the first beam is usable for communications, or both, where the second set of parameters include the indication, the validity time, or both. The operations of 1220 may be performed in accordance with examples as disclosed herein. In some examples, aspects of the operations of 1220 may be performed by a machine learning model manager 930 as described with reference to FIG. 9.

At 1225, the method may include communicating with the second wireless communication device within the second set of time intervals in accordance with the beamforming configuration. The operations of 1225 may be performed in accordance with examples as disclosed herein. In some examples, aspects of the operations of 1225 may be performed by a wireless communication device communicating manager 940 as described with reference to FIG. 9.

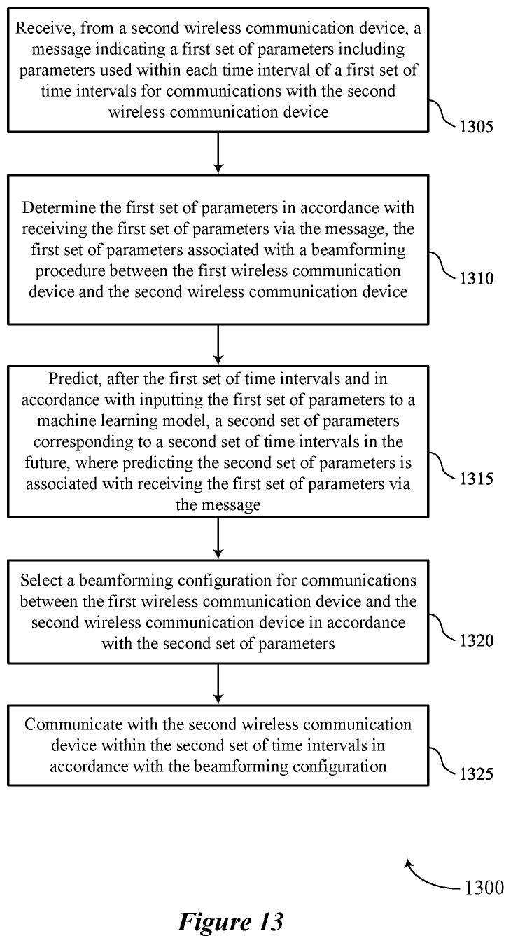

FIG. 13 illustrates a flowchart illustrating a method 1300 that supports techniques for predicting beams and/or beamforming parameters using machine learning models in accordance with one or more aspects of the present disclosure. The operations of the method 1300 may be implemented by an AP or its components as described herein. For example, the operations of the method 1300 may be performed by an AP as described with reference to FIGS. 1-10. In some examples, an AP may execute a set of instructions to control the functional elements of the AP to perform the described functions. Additionally, or alternatively, the AP may perform aspects of the described functions using special-purpose hardware.

At 1305, the method may include receiving, from a second wireless communication device, a message indicating a first set of parameters including parameters used within each time interval of a first set of time intervals for communications with the second wireless communication device. The operations of 1305 may be performed in accordance with examples as disclosed herein. In some examples, aspects of the operations of 1305 may be performed by a wireless communication device communicating manager 940 as described with reference to FIG. 9.

At 1310, the method may include determining the first set of parameters in accordance with receiving the first set of parameters via the message, the first set of parameters associated with a beamforming procedure between the first wireless communication device and the second wireless communication device. The operations of 1310 may be performed in accordance with examples as disclosed herein. In some examples, aspects of the operations of 1310 may be performed by a beamforming parameter manager 925 as described with reference to FIG. 9.

At 1315, the method may include predicting, after the first set of time intervals and in accordance with inputting the first set of parameters to a machine learning model, a second set of parameters corresponding to a second set of time intervals in the future, where predicting the second set of parameters is associated with receiving the first set of parameters via the message. The operations of 1315 may be performed in accordance with examples as disclosed herein. In some examples, aspects of the operations of 1315 may be performed by a machine learning model manager 930 as described with reference to FIG. 9.

At 1320, the method may include selecting a beamforming configuration for communications between the first wireless communication device and the second wireless communication device in accordance with the second set of parameters. The operations of 1320 may be performed in accordance with examples as disclosed herein. In some examples, aspects of the operations of 1320 may be performed by a beamforming configuration manager 935 as described with reference to FIG. 9.

At 1325, the method may include communicating with the second wireless communication device within the second set of time intervals in accordance with the beamforming configuration. The operations of 1325 may be performed in accordance with examples as disclosed herein. In some examples, aspects of the operations of 1325 may be performed by a wireless communication device communicating manager 940 as described with reference to FIG. 9.

It should be noted that the methods described herein describe possible implementations, and that the operations and the steps may be rearranged or otherwise modified and that other implementations are possible. Furthermore, aspects from two or more of the methods may be combined.

The following provides an overview of aspects of the present disclosure:

Aspect 1: A method for wireless communication at a first wireless communication device, comprising: determining a first set of parameters including parameters used within each time interval of a first set of time intervals for communications with a second wireless communication device, the first set of parameters associated with a beamforming procedure between the first wireless communication device and the second wireless communication device; predicting, after the first set of time intervals and in accordance with inputting the first set of parameters to a machine learning model, a second set of parameters corresponding to a second set of time intervals in the future; selecting a beamforming configuration for communications between the first wireless communication device and the second wireless communication device in accordance with the second set of parameters; and communicating with the second wireless communication device within the second set of time intervals in accordance with the beamforming configuration.

Aspect 2: The method of aspect 1, wherein determining the first set of parameters associated with the first set of time intervals comprises communicating with the second wireless communication device via a first beam in accordance with the first set of parameters, wherein predicting the second set of parameters comprises: predicting, using the machine learning model, an indication of whether the first beam is usable for communications with the second wireless communication device over the second set of time intervals, a validity time associated with a time duration that the first beam is usable for communications, or both, wherein the second set of parameters comprise the indication, the validity time, or both.

Aspect 3: The method of any of aspects 1 through 2, further comprising: receiving, from the second wireless communication device, a message indicating the first set of parameters, wherein predicting the second set of parameters is associated with receiving the first set of parameters via the message.

Aspect 4: The method of aspect 3, further comprising: transmitting, to the second wireless communication device, a second message indicating the second set of parameters, wherein selecting the beamforming configuration, communicating within the second set of time intervals, or both, is associated with transmitting the second message.

Aspect 5: The method of any of aspects 1 through 4, further comprising: communicating, with the second wireless communication device, a control message indicating a BI configuration comprising a plurality of service periods usable for communications between the first wireless communication device and the second wireless communication device; and monitoring for communications from the second wireless communication device within at least the first set of time intervals prior to a service period of the plurality of service periods in accordance with the BI configuration, wherein monitoring in accordance with the BI configuration comprises communicating within the service period including the second set of time intervals.

Aspect 6: The method of any of aspects 1 through 5, further comprising: communicating, with the second wireless communication device, a capability message indicating one or more machine learning models supported by the first wireless communication device, supported by the second wireless communication device, or both, the one or more machine learning models including the machine learning model, wherein predicting the second set of parameters is associated with the capability message.

Aspect 7: The method of aspect 6, further comprising: communicating, with the second wireless communication device in accordance with the capability message, an additional message indicating one or more inputs to the machine learning model, wherein inputting the first set of parameters to the machine learning model is associated with the additional message.

Aspect 8: The method of any of aspects 1 through 7, further comprising: performing an SLS procedure, a BRP, or both, with the second wireless communication device in accordance with the beamforming configuration, wherein communicating with the second wireless communication device in accordance with the beamforming configuration is associated with performing the SLS procedure, the BRP, or both.

Aspect 9: The method of aspect 8, wherein performing the SLS procedure, the BRP, or both comprises: performing both the SLS procedure and the BRP in accordance with the beamforming configuration and a difference between the second set of parameters and the first set of parameters being greater than a threshold difference.

Aspect 10: The method of aspect 8, wherein performing the SLS procedure, the BRP, or both comprises: performing the BRP in accordance with the beamforming configuration and a difference between the second set of parameters and the first set of parameters being less than a threshold difference.

Aspect 11: The method of aspect 8, wherein the first wireless communication device is associated with a plurality of beam sectors, a plurality of beams, or both, wherein predicting the second set of parameters comprises: predicting, using the machine learning model, a subset of the plurality of beam sectors, a subset of the plurality of beams, or both, that are to be used for wireless communications with the second wireless communication device, wherein the second set of parameters comprise indications of the subset of the plurality of beam sectors, the subset of the plurality of beams, or both, wherein the SLS procedure, the BRP, or both, are performed across the subset of the plurality of beam sectors, the subset of the plurality of beams, or both.

Aspect 12: The method of any of aspects 1 through 11, wherein the first set of parameters, the second set of parameters, or both, comprise one or more of an AoA of communications between the first wireless communication device and the second wireless communication device, a steering angle of communications between the first wireless communication device and the second wireless communication device, a TxSID or an RxSID associated with the first wireless communication device, the second wireless communication device, or both, a width of a beam used for communication by the first wireless communication device, the second wireless communication device, or both, a validity time associated with the beam used for communication by the first wireless communication device, the second wireless communication device, or both, or channel quality metrics associated with communications exchanged between the first wireless communication device and the second wireless communication device.

Aspect 13: The method of any of aspects 1 through 12, further comprising: performing a set of measurements on communications performed within the second set of time intervals; and training the machine learning model by inputting the second set of parameters, the set of measurements, or both, into the machine learning model.

Aspect 14: The method of any of aspects 1 through 13, further comprising: communicating within the first set of time intervals within a first frequency band, wherein determining the first set of parameters is associated with communicating within the first frequency band, wherein predicting the second set of parameters comprises predicting, using the machine learning model, a second frequency band for communications between the first wireless communication device and the second wireless communication device, wherein the second set of parameters comprise the second frequency band, and wherein communicating within the second set of time intervals is performed within the second frequency band.

Aspect 15: The method of any of aspects 1 through 14, wherein the first wireless communication device comprises an STA, a first multi-link device, or both, and the second wireless communication device comprises an AP, a second multi-link device, or both.

Aspect 16: The method of any of aspects 1 through 15, wherein the first wireless communication device comprises an AP, a first multi-link device, or both, and the second wireless communication device comprises an STA, a second multi-link device, or both.

Aspect 17: The method of any of aspects 1 through 16, wherein the first wireless communication device comprises a first STA, and the second wireless communication device comprises a second STA.

Aspect 18: The method of any of aspects 1 through 17, wherein the machine learning model comprises one or more of a time series-based prediction model, a machine learning classifier, or a reinforcement learning model.

Aspect 19: The method of any of aspects 1 through 18, further comprising: receiving, from the second wireless communication device, a message indicating the machine learning model, wherein determining the first set of parameters, predicting the second set of parameters, or both, is based at least in part on receiving the message indicating the machine learning model.

Aspect 20: The method of any of aspects 1 through 19, wherein predicting the second set of parameters comprises: predicting, using the machine learning model, one or more mobility metrics associated with a relative level of mobility for the first wireless communication device, the second wireless communication device, or both, wherein the second set of parameters comprise the one or more mobility metrics.

Aspect 21: The method of any of aspects 1 through 20, further comprising: determining a frequency or periodicity of a plurality of sectorized transmissions exchanged as part of the beamforming procedure between the first wireless communication device and the second wireless communication device in accordance with the second set of parameters, wherein the plurality of sectorized transmissions include an identifier associated with the first wireless communication device, an identifier associated with a communication sector of the first wireless communication device, or both.

Aspect 22: An apparatus for wireless communication at a first wireless communication device, comprising a processor; memory coupled with the processor; and instructions stored in the memory and executable by the processor to cause the apparatus to perform a method of any of aspects 1 through 21.

Aspect 23: An apparatus for wireless communication at a first wireless communication device, comprising at least one means for performing a method of any of aspects 1 through 21.

Aspect 24: A non-transitory computer-readable medium storing code for wireless communication at a first wireless communication device, the code comprising instructions executable by a processor to perform a method of any of aspects 1 through 21.

Techniques described herein may be used for various wireless communications systems such as code division multiple access (CDMA), time division multiple access (TDMA), frequency division multiple access (FDMA), orthogonal frequency division multiple access (OFDMA), single carrier frequency division multiple access (SC-FDMA), and other systems. The terms “system” and “network” are often used interchangeably. A code division multiple access (CDMA) system may implement a radio technology such as CDMA2000, Universal Terrestrial Radio Access (UTRA), etc. CDMA2000 covers IS-2000, IS-95, and IS-856 standards. IS-2000 Releases may be commonly referred to as CDMA2000 1×, 1×, etc. IS-856 (TIA-856) is commonly referred to as CDMA2000 1×EV-DO, High Rate Packet Data (HRPD), etc. UTRA includes Wideband CDMA (WCDMA) and other variants of CDMA. A time division multiple access (TDMA) system may implement a radio technology such as Global System for Mobile Communications (GSM). An orthogonal frequency division multiple access (OFDMA) system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM, etc.

The wireless communications system or systems described herein may support synchronous or asynchronous operation. For synchronous operation, the stations may have similar frame timing, and transmissions from different stations may be approximately aligned in time. For asynchronous operation, the stations may have different frame timing, and transmissions from different stations may not be aligned in time. The techniques described herein may be used for either synchronous or asynchronous operations.

The downlink transmissions described herein may also be called forward link transmissions while the uplink transmissions may also be called reverse link transmissions. Each communication link described herein—including, for example, WLAN 100, and wireless communications system 200 of FIGS. 1 and 2—may include one or more carriers, and each carrier may be a signal made up of multiple sub-carriers (for example, waveform signals of different frequencies).

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (for example, a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (for example, A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can include RAM, ROM, electrically erasable programmable read-only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, digital subscriber line (DSL), or wireless technologies such as infrared, radio, and microwave are included in the definition of medium. Disk and disc, as used herein, include CD, laser disc, optical disc, digital versatile disc (DVD), floppy disk and Blu-ray disc. Disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. An apparatus for wireless communication at a first wireless communication device, comprising:
a processor; and
memory coupled with the processor and storing instructions executable by the processor to cause the apparatus to:
determine a first set of parameters comprising parameters used for previous communications with a second wireless communication device within each time interval of a first set of time intervals, the first set of parameters associated with a beamforming procedure between the first wireless communication device and the second wireless communication device;
predict, after the first set of time intervals and in accordance with inputting the first set of parameters to a machine learning model, a second set of parameters corresponding to a second set of time intervals in the future;
select a beamforming configuration for communications between the first wireless communication device and the second wireless communication device in accordance with the second set of parameters; and
communicate with the second wireless communication device within the second set of time intervals in accordance with the beamforming configuration.

2. The apparatus of claim 1, wherein determining the first set of parameters associated with the first set of time intervals comprises communicating with the second wireless communication device via a first beam in accordance with the first set of parameters, wherein the instructions to predict the second set of parameters are executable by the processor to cause the apparatus to:
predict, using the machine learning model, an indication of whether the first beam is usable for communications with the second wireless communication device over the second set of time intervals, a validity time associated with a time duration that the first beam is usable for communications, or both, wherein the second set of parameters comprise the indication, the validity time, or both.

3. The apparatus of claim 1, wherein the instructions are further executable by the processor to cause the apparatus to receive, from the second wireless communication device, a message indicating the first set of parameters, wherein predicting the second set of parameters is associated with receiving the first set of parameters via the message.

4. The apparatus of claim 3, wherein the instructions are further executable by the processor to cause the apparatus to transmit, to the second wireless communication device, a second message indicating the second set of parameters, wherein selecting the beamforming configuration, communicating within the second set of time intervals, or both, is associated with transmitting the second message.

5. The apparatus of claim 1, wherein the instructions are further executable by the processor to cause the apparatus to:
communicate, with the second wireless communication device, a control message indicating a beacon interval configuration comprising a plurality of service periods usable for communications between the first wireless communication device and the second wireless communication device; and
monitor for communications from the second wireless communication device within at least the first set of time intervals prior to a service period of the plurality of service periods in accordance with the beacon interval configuration, wherein monitoring in accordance with the beacon interval configuration comprises communicating within the service period including the second set of time intervals.

6. The apparatus of claim 1, wherein the instructions are further executable by the processor to cause the apparatus to communicate, with the second wireless communication device, a capability message indicating one or more machine learning models supported by the first wireless communication device, supported by the second wireless communication device, or both, the one or more machine learning models including the machine learning model, wherein predicting the second set of parameters is associated with the capability message.

7. The apparatus of claim 6, wherein the instructions are further executable by the processor to cause the apparatus to communicate, with the second wireless communication device in accordance with the capability message, an additional message indicating one or more inputs to the machine learning model, wherein inputting the first set of parameters to the machine learning model is associated with the additional message.

8. The apparatus of claim 1, wherein the instructions are further executable by the processor to cause the apparatus to perform a sector-level sweep procedure, a beam refinement procedure, or both, with the second wireless communication device in accordance with the beamforming configuration, wherein communicating with the second wireless communication device in accordance with the beamforming configuration is associated with performing the sector-level sweep procedure, the beam refinement procedure, or both.

9. The apparatus of claim 8, wherein the instructions to perform the sector-level sweep procedure, the beam refinement procedure, or both are executable by the processor to cause the apparatus to perform both the sector-level sweep procedure and the beam refinement procedure in accordance with the beamforming configuration and a difference between the second set of parameters and the first set of parameters being greater than a threshold difference.

10. The apparatus of claim 8, wherein the instructions to perform the sector-level sweep procedure, the beam refinement procedure, or both are executable by the processor to cause the apparatus to perform the beam refinement procedure in accordance with the beamforming configuration and a difference between the second set of parameters and the first set of parameters being less than a threshold difference.

11. The apparatus of claim 8, wherein the first wireless communication device is associated with a plurality of beam sectors, a plurality of beams, or both, wherein the instructions to predict the second set of parameters are executable by the processor to cause the apparatus to predict, using the machine learning model, a subset of the plurality of beam sectors, a subset of the plurality of beams, or both, that are to be used for wireless communications with the second wireless communication device, wherein the second set of parameters comprise indications of the subset of the plurality of beam sectors, the subset of the plurality of beams, or both, wherein the sector-level sweep procedure, the beam refinement procedure, or both, are performed across the subset of the plurality of beam sectors, the subset of the plurality of beams, or both.

12. The apparatus of claim 1, wherein the first set of parameters, the second set of parameters, or both, comprise one or more of an angle of arrival of communications between the first wireless communication device and the second wireless communication device, a steering angle of communications between the first wireless communication device and the second wireless communication device, a transmit sector identifier or a receive sector identifier associated with the first wireless communication device, the second wireless communication device, or both, a width of a beam used for communication by the first wireless communication device, the second wireless communication device, or both, a validity time associated with the beam used for communication by the first wireless communication device, the second wireless communication device, or both, or channel quality metrics associated with communications exchanged between the first wireless communication device and the second wireless communication device.

13. The apparatus of claim 1, wherein the instructions are further executable by the processor to cause the apparatus to:
perform a set of measurements on communications performed within the second set of time intervals; and
train the machine learning model by inputting the second set of parameters, the set of measurements, or both, into the machine learning model.

14. The apparatus of claim 1, wherein the instructions are further executable by the processor to cause the apparatus to communicate within the first set of time intervals within a first frequency band, wherein determining the first set of parameters is associated with communicating within the first frequency band, wherein predicting the second set of parameters comprises predicting, using the machine learning model, a second frequency band for communications between the first wireless communication device and the second wireless communication device, wherein the second set of parameters comprise the second frequency band, and wherein communicating within the second set of time intervals is performed within the second frequency band.

15. The apparatus of claim 1, wherein the first wireless communication device comprises a station (STA), a first multi-link device, or both, and wherein the second wireless communication device comprises an access point (AP), a second multi-link device, or both.

16. The apparatus of claim 1, wherein the first wireless communication device comprises an access point (AP), a first multi-link device, or both, and wherein the second wireless communication device comprises a station (STA), a second multi-link device, or both.

17. The apparatus of claim 1, wherein the first wireless communication device comprises a first station (STA), and wherein the second wireless communication device comprises a second STA.

18. The apparatus of claim 1, wherein the machine learning model comprises one or more of a time series-based prediction model, a machine learning classifier, or a reinforcement learning model.

19. The apparatus of claim 1, wherein the instructions are further executable by the processor to cause the apparatus to receive, from the second wireless communication device, a message indicating the machine learning model, wherein determining the first set of parameters, predicting the second set of parameters, or both, is based at least in part on receiving the message indicating the machine learning model.

20. The apparatus of claim 1, wherein the instructions to predict the second set of parameters are executable by the processor to cause the apparatus to predict, using the machine learning model, one or more mobility metrics associated with a relative level of mobility for the first wireless communication device, the second wireless communication device, or both, wherein the second set of parameters comprise the one or more mobility metrics.

21. The apparatus of claim 1, wherein the instructions are further executable by the processor to cause the apparatus to determine a frequency or periodicity of a plurality of sectorized transmissions exchanged as part of the beamforming procedure between the first wireless communication device and the second wireless communication device in accordance with the second set of parameters, wherein the plurality of sectorized transmissions include an identifier associated with the first wireless communication device, an identifier associated with a communication sector of the first wireless communication device, or both.

22. A method for wireless communication at a first wireless communication device, comprising:
determining a first set of parameters comprising parameters used within each time interval of a first set of time intervals for previous communications with a second wireless communication device, the first set of parameters associated with a beamforming procedure between the first wireless communication device and the second wireless communication device;
predicting, after the first set of time intervals and in accordance with inputting the first set of parameters to a machine learning model, a second set of parameters corresponding to a second set of time intervals in the future;
selecting a beamforming configuration for communications between the first wireless communication device and the second wireless communication device in accordance with the second set of parameters; and
communicating with the second wireless communication device within the second set of time intervals in accordance with the beamforming configuration.

23. The method of claim 22, wherein determining the first set of parameters associated with the first set of time intervals comprises communicating with the second wireless communication device via a first beam in accordance with the first set of parameters, wherein predicting the second set of parameters comprises predicting, using the machine learning model, an indication of whether the first beam is usable for communications with the second wireless communication device over the second set of time intervals, a validity time associated with a time duration that the first beam is usable for communications, or both, wherein the second set of parameters comprise the indication, the validity time, or both.

24. The method of claim 22, further comprising receiving, from the second wireless communication device, a message indicating the first set of parameters, wherein predicting the second set of parameters is associated with receiving the first set of parameters via the message.

25. The method of claim 24, further comprising transmitting, to the second wireless communication device, a second message indicating the second set of parameters, wherein selecting the beamforming configuration, communicating within the second set of time intervals, or both, is associated with transmitting the second message.

26. The method of claim 22, further comprising:
communicating, with the second wireless communication device, a control message indicating a beacon interval configuration comprising a plurality of service periods usable for communications between the first wireless communication device and the second wireless communication device; and
monitoring for communications from the second wireless communication device within at least the first set of time intervals prior to a service period of the plurality of service periods in accordance with the beacon interval configuration, wherein monitoring in accordance with the beacon interval configuration comprises communicating within the service period including the second set of time intervals.

27. The method of claim 22, further comprising communicating, with the second wireless communication device, a capability message indicating one or more machine learning models supported by the first wireless communication device, supported by the second wireless communication device, or both, the one or more machine learning models including the machine learning model, wherein predicting the second set of parameters is associated with the capability message.

28. The method of claim 27, further comprising communicating, with the second wireless communication device in accordance with the capability message, an additional message indicating one or more inputs to the machine learning model, wherein inputting the first set of parameters to the machine learning model is associated with the additional message.

29. The method of claim 22, further comprising performing a sector-level sweep procedure, a beam refinement procedure, or both, with the second wireless communication device in accordance with the beamforming configuration, wherein communicating with the second wireless communication device in accordance with the beamforming configuration is associated with performing the sector-level sweep procedure, the beam refinement procedure, or both.

30. The method of claim 29, wherein performing the sector-level sweep procedure, the beam refinement procedure, or both comprises performing both the sector-level sweep procedure and the beam refinement procedure in accordance with the beamforming configuration and a difference between the second set of parameters and the first set of parameters being greater than a threshold difference.

31. The method of claim 29, wherein performing the sector-level sweep procedure, the beam refinement procedure, or both comprises performing the beam refinement procedure in accordance with the beamforming configuration and a difference between the second set of parameters and the first set of parameters being less than a threshold difference.

32. The method of claim 29, wherein the first wireless communication device is associated with a plurality of beam sectors, a plurality of beams, or both, wherein predicting the second set of parameters comprises predicting, using the machine learning model, a subset of the plurality of beam sectors, a subset of the plurality of beams, or both, that are to be used for wireless communications with the second wireless communication device, wherein the second set of parameters comprise indications of the subset of the plurality of beam sectors, the subset of the plurality of beams, or both, wherein the sector-level sweep procedure, the beam refinement procedure, or both, are performed across the subset of the plurality of beam sectors, the subset of the plurality of beams, or both.

33. The method of claim 22, wherein the first set of parameters, the second set of parameters, or both, comprise one or more of an angle of arrival of communications between the first wireless communication device and the second wireless communication device, a steering angle of communications between the first wireless communication device and the second wireless communication device, a transmit sector identifier or a receive sector identifier associated with the first wireless communication device, the second wireless communication device, or both, a width of a beam used for communication by the first wireless communication device, the second wireless communication device, or both, a validity time associated with the beam used for communication by the first wireless communication device, the second wireless communication device, or both, or channel quality metrics associated with communications exchanged between the first wireless communication device and the second wireless communication device.

34. The method of claim 22, further comprising:
performing a set of measurements on communications performed within the second set of time intervals; and
training the machine learning model by inputting the second set of parameters, the set of measurements, or both, into the machine learning model.

35. The method of claim 22, further comprising communicating within the first set of time intervals within a first frequency band, wherein determining the first set of parameters is associated with communicating within the first frequency band, wherein predicting the second set of parameters comprises predicting, using the machine learning model, a second frequency band for communications between the first wireless communication device and the second wireless communication device, wherein the second set of parameters comprise the second frequency band, and wherein communicating within the second set of time intervals is performed within the second frequency band.

36. The method of claim 22, wherein the first wireless communication device comprises a station (STA), a first multi-link device, or both, and wherein the second wireless communication device comprises an access point (AP), a second multi-link device, or both.

37. The method of claim 22, wherein the first wireless communication device comprises an access point (AP), a first multi-link device, or both, and wherein the second wireless communication device comprises a station (STA), a second multi-link device, or both.

38. The method of claim 22, wherein the first wireless communication device comprises a first station (STA), and wherein the second wireless communication device comprises a second STA.

39. The method of claim 22, wherein the machine learning model comprises one or more of a time series-based prediction model, a machine learning classifier, or a reinforcement learning model.

40. The method of claim 22, further comprising receiving, from the second wireless communication device, a message indicating the machine learning model, wherein determining the first set of parameters, predicting the second set of parameters, or both, is based at least in part on receiving the message indicating the machine learning model.

41. The method of claim 22, wherein predicting the second set of parameters comprises predicting, using the machine learning model, one or more mobility metrics associated with a relative level of mobility for the first wireless communication device, the second wireless communication device, or both, wherein the second set of parameters comprise the one or more mobility metrics.

42. The method of claim 22, further comprising determining a frequency or periodicity of a plurality of sectorized transmissions exchanged as part of the beamforming procedure between the first wireless communication device and the second wireless communication device in accordance with the second set of parameters, wherein the plurality of sectorized transmissions include an identifier associated with the first wireless communication device, an identifier associated with a communication sector of the first wireless communication device, or both.
